(19) United States
(12) Patent Application Publication
(10) Pub. No.: US 2026/0304185 A1
(43) Pub. Date: Oct. 1, 2026

(54) METHOD PERFORMED BY NODE IN WIRELESS COMMUNICATION SYSTEM AND ELECTRONIC APPARATUS THEREOF

(71) Applicant: Samsung Electronics Co., Ltd., Suwon-si, Gyeonggi-do (KR)

(72) Inventors: Bowen YANG, Beijing (CN); Nan JIANG, Beijing (CN); Di SU, Beijing (CN); Chen QIAN, Beijing (CN); Yanna BAI, Beijing (CN); Yu XIAO, Beijing (CN); Yupeng CUI, Beijing (CN)

(21) Appl. No.: 19/475,602

(22) PCT Filed: Mar. 29, 2024
(86) PCT No.: PCT/KR2024/004100

§ 371 Date: Oct. 15, 2025

(30) Foreign Application Priority Data
Apr. 17, 2023 (CN) 202310409278.3
May 26, 2023 (CN) 202310613700.7

(51) Int. Cl. H04W 24/10

(52) U.S. Cl. CPC H04W 24/10

(57) ABSTRACT

The present disclosure relates to a 5G communication system or a 6G communication system for supporting higher data rates beyond a 4G communication system such as long term evolution (LTE). The present disclosure provides a method performed by a node in a wireless communication system and an electronic apparatus thereof. The method performed by the first node in the communication system includes: receiving a first signal on a first resource for channel measurement; determining a second resource; and reporting channel state information which is on the second resource.

### TECHNICAL FIELD

The present disclosure relates to the communication technical field, and in particular, relates to a method performed by a node in a wireless communication system and an electronic apparatus thereof.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Solution to Problem

According to an embodiment of the present disclosure, there is provided a method performed by a first node in a wireless communication system, including: receiving a first signal on a first resource for channel measurement; determining a second resource; and reporting channel state information which is on the second resource.

The determining of the second resource may include at least one of: determining the second resource based on first information regarding the second resource received from a second node; and determining the second resource based on the first resource.

The determining of the second resource based on the first resource may include determining the second resource as at least one of: a sub-band, a bandwidth part (BWP) or a frequency band where the first resource is located; and a sub-band, a bandwidth part (BWP) or a frequency band adjacent to the first resource.

The first information may include at least one of information of a time domain resource, information of a frequency domain resource, information of a space domain resource and information on a position of the second resource relative to the first resource.

The information on the position of the second resource relative to the first resource may include at least one of: an offset between an initial time domain physical resource of the second resource and an initial time domain physical resource of the first resource; an offset between the initial time domain physical resource of the second resource and an end time domain physical resource of the first resource; an offset between an end time domain physical resource of the second resource and the initial time domain physical resource of the first resource; an offset between the end time domain physical resource of the second resource and the end time domain physical resource of the first resource; an offset between an initial frequency domain physical resource of the second resource and an initial frequency domain physical resource of the first resource; an offset between the initial frequency domain physical resource of the second resource and an end frequency domain physical resource of the first resource; an offset between an end frequency domain physical resource of the second resource and the initial frequency domain physical resource of the first resource; and an offset between the end frequency domain physical resource of the second resource and the end frequency domain physical resource of the first resource.

The method may further include: reporting capability information, wherein the capability information comprises at least one of: information of a minimum time domain density of the first signal required for acquiring channel state information, information of a maximum time domain interval of the first signal required for acquiring channel state information, information of a time domain range in which channel state information is acquired, information of a minimum frequency domain density of the first signal required for acquiring channel state information, information of a maximum frequency domain interval of the first signal required for acquiring channel state information, information of a frequency domain range in which channel state information is acquired, and information of a minimum space domain density of the first signal required for acquiring channel state information.

The method may further include: receiving, from the second node, second information for channel state information measurement and/or report, wherein the channel state information measurement and/or report includes at least one of: measuring and/or reporting the channel state information which is on the first resource, and measuring and/or reporting the channel state information which is on the second resource.

The method may further include: determining the channel state information measurement and/or report according to whether the first information is received.

The determining of the channel state information measurement and/or report according to whether the first information is received may include at least one of: measuring and/or reporting the channel state information which is on the second resource when the first information is received; and measuring and/or reporting the channel state information which is on the first resource when the first information is not received.

The method may further include: receiving third information on time when the channel state information is reported.

The third information may include at least one of: an offset between a time point at which the first node receives the first signal and a latest time point at which the first node reports the channel state information; and an offset between a latest time point at which the first node reports the channel state information which is on the first resource and a latest time point at which the first node reports the channel state information which is on the second resource.

The method may further include: determining the time when the channel state information which is on the second resource is reported according to at least one of: an interval between subcarriers; a capability reported by the first node; and channel state information that needs to be reported configured by the second node.

The channel state information which is on the second resource may be acquired through a neural network, wherein the neural network includes a plurality of cascaded sub-neural networks, wherein at least one of the plurality of sub-neural networks is used for acquiring channel state information which is on partial resource of the second resource.

According to an embodiment of the present disclosure, there is provided a method performed by a second node in a wireless communication system, including: transmitting, to a first node, a first signal on a first resource for channel measurement; and receiving channel state information which is on a second resource transmitted by the first node.

The method may further include: transmitting first information regarding the second resource to the first node.

The first information may include at least one of information of a time domain resource, information of a frequency domain resource, information of a space domain resource and information on a position of the second resource relative to the first resource.

The information on the position of the second resource relative to the first resource may include at least one of: an offset between an initial time domain physical resource of the second resource and an initial time domain physical resource of the first resource; an offset between the initial time domain physical resource of the second resource and an end time domain physical resource of the first resource; an offset between an end time domain physical resource of the second resource and the initial time domain physical resource of the first resource; an offset between the end time domain physical resource of the second resource and the end time domain physical resource of the first resource; an offset between an initial frequency domain physical resource of the second resource and an initial frequency domain physical resource of the first resource; an offset between the initial frequency domain physical resource of the second resource and an end frequency domain physical resource of the first resource; an offset between an end frequency domain physical resource of the second resource and the initial frequency domain physical resource of the first resource; and an offset between the end frequency domain physical resource of the second resource and the end frequency domain physical resource of the first resource.

The method may further include: receiving capability information transmitted by the first node, wherein the capability information includes at least one of: information of a minimum time domain density of the first signal required for acquiring channel state information, information of a maximum time domain interval of the first signal required for acquiring channel state information, information of a time domain range in which channel state information is acquired, information of a minimum frequency domain density of the first signal required for acquiring channel state information, information of a maximum frequency domain interval of the first signal required for acquiring channel state information, information of a frequency domain range in which channel state information is acquired, and information of a minimum space domain density of the first signal required for acquiring channel state information.

The method may further include: transmitting second information for channel state information measurement and/or report to the first node, wherein the channel state information measurement and/or report includes at least one of: measuring and/or reporting the channel state information which is on the first resource, and measuring and/or reporting the channel state information which is on the second resource.

The method may further include: transmitting third information on time when the channel state information is reported to the first node.

The third information may include at least one of: an offset between a time point at which the first node receives the first signal and a latest time point at which the first node reports the channel state information; and an offset between a latest time point at which the first node reports the channel state information which is on the first resource and a latest time point at which the first node reports the channel state information which is on the second resource.

According to an embodiment of the present disclosure, there is provided a first node, including: a transceiver; and a controller coupled to the transceiver and configured to execute the above-described method.

According to an embodiment of the present disclosure, there is provided a second node, including: a transceiver; and a controller coupled to the transceiver and configured to execute the above-described method.

According to an embodiment of the present disclosure, a channel state information acquisition method is provided, including: acquiring a reception signal on a first resource; and acquiring channel state information which is on a second resource through a neural network based on the reception signal, wherein the neural network includes a plurality of cascaded sub-neural networks, wherein each of the sub-neural networks is used for acquiring channel state information which is on partial resource of the second resource.

The each sub-neural network may further be used for acquiring channel state information on at least one of a time domain resource, a frequency domain resource and a space domain resource of the second resource.

The method may further include: acquiring related information of the second resource, wherein the acquiring the channel state information which is on the second resource through the neural network based on the reception signal may include: acquiring the channel state information which is on the second resource through the neural network based on the reception signal and the related information.

The first resource may be used for a reference signal.

The acquiring of the channel state information which is on the second resource through the neural network based on the reception signal and the related information may include: acquiring the channel state information which is on the second resource through the neural network based on the reference signal, the reception signal and the related information.

The acquiring of the channel state information which is on the second resource through the neural network based on the reception signal may include: acquiring channel state information which is on the first resource based on the reception signal;

and acquiring the channel state information which is on the second resource through the neural network based on the channel state information which is on the first resource.

The acquiring of the channel state information which is on the second resource through the neural network based on the reception signal may include: acquiring channel state information which is on the first resource based on the reception signal; and acquiring channel state information which is on a third resource based on the channel state information which is on the first resource; and acquiring the channel state information which is on the second resource through the neural network based on the channel state information which is on the third resource, or based on the channel state information which is on the first resource and the channel state information which is on the third resource.

The second resource may include at least one of: the second resource different from the first resource; the second resource different from the first resource and the third resource; the second resource including the first resource and resources other than the first resource; the second resource including the first resource, the third resource and resources other than the first resource and the third resource; a time domain offset between the second resource and the first resource being greater than a first threshold; a frequency domain offset between the second resource and the first resource being greater than a second threshold; and the second resource whose space domain resource is different from a space domain resource of the first resource.

The number of activated sub-neural networks in the plurality of sub-neural networks may be determined based on at least one of a processing delay requirement for acquiring the channel state information, an energy consumption requirement for acquiring the channel state information, an accuracy requirement for acquiring the channel state information, and a resource dimension of the second resource, wherein the resource dimension of the second resource is included in the related information of the second resource.

According to an embodiment of the present disclosure, a channel state information acquisition method is provided, including: acquiring a reception signal on a first resource; acquiring related information of the second resource; and acquiring channel state information which is on the second resource through a neural network based on the reception signal and the related information.

The first resource may be used for a reference signal.

The acquiring of the channel state information which is on the second resource through the neural network based on the reception signal and the related information may include: acquiring the channel state information which is on the second resource through the neural network based on the reference signal, the reception signal and the related information.

The acquiring of the channel state information which is on the second resource through the neural network based on the reception signal and the related information may include: acquiring channel state information which is on the first resource based on the reception signal; and acquiring the channel state information which is on the second resource through the neural network based on the channel state information which is on the first resource and the related information.

The acquiring of the channel state information which is on the second resource through the neural network based on the reception signal and the related information may include: acquiring the channel state information which is on the first resource based on the reception signal; acquiring channel state information which is on a third resource based on the channel state information which is on the first resource; and acquiring the channel state information which is on the second resource through the neural network based on the channel state information which is on the third resource and the related information, or based on the channel state information which is on the first resource, the channel state information which is on the third resource and the related information.

The second resource may include at least one of: the second resource different from the first resource; the second resource different from the first resource and the third resource; the second resource including the first resource and resources other than the first resource; the second resource including the first resource, the third resource and resources other than the first resource and the third resource; a time domain offset between the second resource and the first resource being greater than a first threshold; a frequency domain offset between the second resource and the first resource being greater than a second threshold; and the second resource whose space domain resource is different from a space domain resource of the first resource.

The neural network may include a plurality of cascaded sub-neural networks, wherein at least one of the plurality of sub-neural networks is used for acquiring channel state information which is on partial resource of the second resource.

According to an embodiment of the present disclosure, there is provided an electronic apparatus, including: a transceiver; and a controller coupled to the transceiver and configured to execute the above-described method.

According to an embodiment of the present disclosure, there is provided a computer-readable medium, storing computer-executable instructions thereon, wherein when the instructions are executed, the aforementioned method is executed.

According to an exemplary embodiment of the present disclosure, by using the neural network including the plurality of cascaded sub-neural networks, a communication node may be enabled to accurately acquire the channel state information through reference signals with lower density and/or lower number distribution (e.g., sounding reference signals, channel state information reference signals, demodulation reference signals, etc.), thereby reducing a resource overhead of the reference signal, and improving a resource utilization rate and performance of a wireless communication system; According to the physical resource dimensions where the channel state information that needs to be acquired is located, different sub-neural networks are cascaded to obtain the channel state information that needs to be acquired on all the physical resource dimensions, so that the communication node may accurately acquire the channel state information through multiple lightweight sub-neural networks, thereby reducing storage resources required to store neural network parameters and computing resources required to run the neural network. Meanwhile, each of lightweight sub-neural network models may be trained independently, which greatly reduces difficulty in training the neural network model. On an aspect, by using the related information, the neural network may be enabled to acquire priori information implied in the related information, so that output accuracy of the neural network is improved, and the neural network may be enabled to flexibly adjust a range of its output channel state information through the resource position where the unknown channel state information is located.

### BRIEF DESCRIPTION OF DRAWINGS

These and other targets and features of the present disclosure will become clearer from the following description, taken in conjunction with the accompanying drawings in which:

FIG. 1 illustrates an example wireless network according to an embodiment of the present disclosure.

FIG. 2a illustrates example wireless transmission and reception paths according to embodiments of the present disclosure.

FIG. 2b illustrates example wireless transmission and reception paths according to embodiments of the present disclosure.

FIG. 3a illustrates an example user equipment (UE) according to the embodiments of the present disclosure.

FIG. 3b illustrates an example gNodeB (gNB) according to the embodiments of the present disclosure.

FIG. 4 illustrates a schematic diagram of SRS resource configuration supporting two antenna ports according to an embodiment of the present disclosure.

FIG. 5 illustrates a flowchart of a channel state information acquisition method according to an embodiment of the present disclosure.

FIG. 6 illustrates a flowchart of a channel state information acquisition method according to an embodiment of the present disclosure.

FIG. 7 illustrates a schematic diagram of a channel state information acquisition method according to an embodiment of the present disclosure.

FIG. 8 illustrates a schematic diagram of a sub-neural network according to an embodiment of the present disclosure.

FIG. 9 illustrates a schematic diagram of a neural network according to an embodiment of the present disclosure.

FIG. 10 illustrates a schematic diagram of a neural network according to an embodiment of the present disclosure.

FIG. 11 illustrates a schematic diagram of training and inferring of a neural network according to an embodiment of the present disclosure.

FIG. 12 illustrates a schematic diagram of a neural network according to an embodiment of the present disclosure.

FIG. 13 illustrates a flowchart of a method performed by a first node in a wireless communication system according to an embodiment of the present disclosure.

FIG. 14 illustrates a flowchart of a method performed by a second node in a wireless communication system according to an embodiment of the present disclosure.

FIG. 15 illustrates a block diagram of a first node according to an embodiment of the present disclosure.

FIG. 16 illustrates a block diagram of a second node according to an embodiment of the present disclosure.

### BEST MODE FOR CARRYING OUT THE INVENTION

In one embodiment, a method performed by a first node in wireless a communication system is provided. The method comprising: receiving a first signal on a first resource for channel measurement; determining a second resource; and reporting channel state information on the second resource.

In one embodiment, the method, wherein the determining of the second resource comprises at least one of: determining the second resource based on first information regarding the second resource received from a second node; or determining the second resource based on the first resource.

In one embodiment, the method, wherein the determining of the second resource based on the first resource comprises determining the second resource as at least one of: sub-bands, bandwidth parts (BWPs) or frequency bands where the first resource is located; or sub-bands, bandwidth parts (BWPs) or frequency bands adjacent to the first resource.

In one embodiment, the method, wherein the first information regarding the second resource comprises at least one of: information of a time domain resource, information of a frequency domain resource, information of a space domain resource, or information on a position of the second resource relative to the first resource.

In one embodiment, the method, wherein the information on the position of the second resource relative to the first resource comprises at least one of: an offset between an initial time domain physical resource of the second resource and an initial time domain physical resource of the first resource; an offset between the initial time domain physical resource of the second resource and an end time domain physical resource of the first resource; an offset between an end time domain physical resource of the second resource and the initial time domain physical resource of the first resource; an offset between the end time domain physical resource of the second resource and the end time domain physical resource of the first resource; an offset between an initial frequency domain physical resource of the second resource and an initial frequency domain physical resource of the first resource; an offset between the initial frequency domain physical resource of the second resource and an end frequency domain physical resource of the first resource; an offset between an end frequency domain physical resource of the second resource and the initial frequency domain physical resource of the first resource; or an offset between the end frequency domain physical resource of the second resource and the end frequency domain physical resource of the first resource.

In one embodiment, the method, further comprising: reporting capability information, wherein the capability information comprises at least one of: information of a minimum time domain density of the first signal required for acquiring channel state information, information of a maximum time domain interval of the first signal required for acquiring channel state information, information of a time domain range in which channel state information is acquired, information of a minimum frequency domain density of the first signal required for acquiring channel state information, information of a maximum frequency domain interval of the first signal required for acquiring channel state information, information of a frequency domain range in which channel state information is acquired, or information of a minimum space domain density of the first signal required for acquiring channel state information.

In one embodiment, the method, further comprising: receiving, from the second node, second information including indication information of on which resource measuring and/or reporting channel state information, wherein the channel state information measurement and/or report comprises at least one of: measuring and/or reporting the channel state information which is on the first resource, or measuring and/or reporting the channel state information which is on the second resource.

In one embodiment, the method, further comprising: determining the channel state information measurement and/or report according to whether the first information is received, wherein, measuring and/or reporting the channel state information which is on the second resource when the first information is received; and wherein, measuring and/or reporting the channel state information which is on the first resource when the first information is not received.

In one embodiment, the method, further comprising: receiving third information on time when the channel state information is reported, wherein the third information comprises at least one of: an offset between a time point at which the first node receives the first signal and a latest time point at which the first node reports the channel state information; or an offset between a latest time point at which the first node reports the channel state information which is on the first resource and a latest time point at which the first node reports the channel state information which is on the second resource.

In one embodiment, the method, further comprising: determining the time when the channel state information is reported on the second resource according to at least one of: an interval between subcarriers; a capability reported by the first node; or channel state information that needs to be reported configured by the second node.

In one embodiment, the method, wherein the channel state information which is on the second resource is acquired through a neural network, wherein the neural network comprises a plurality of cascaded sub-neural networks, wherein at least one of the plurality of sub-neural networks is used for acquiring channel state information which is on partial resource of the second resource.

In one embodiment, a method performed by a second node in wireless a communication system is provided. The method comprising: transmitting a first signal on a first resource for channel measurement to a first node; and receiving channel state information on a second resource from the first node.

In one embodiment, the method, further comprising: transmitting first information regarding the second resource to the first node, wherein the first information comprises at least one of: information of a time domain resource, information of a frequency domain resource, information of a space domain resource, or information on a position of the second resource relative to the first resource.

In one embodiment, a first node in wireless a communication system is provided. The first node comprising: a transceiver; and a controller coupled to the transceiver and configured to: receive a first signal on a first resource for channel measurement; determine a second resource; and report channel state information on the second resource.

In one embodiment, a second node in wireless a communication system is provided. The second node comprising: a transceiver; and a controller coupled to the transceiver and configured to: transmit a first signal on a first resource for channel measurement to a first node; and receive channel state information on a second resource from the first node.

### MODE FOR THE INVENTION

The description is provided below with reference to the accompanying drawings to facilitate comprehensive understanding of various embodiments of the present disclosure as defined by the claims and the equivalents thereof. This description includes various specific details to help with understanding but should only be considered illustrative. Consequently, those ordinarily skilled in the art will realize that various embodiments described here can be varied and modified without departing from the scope and spirit of the present disclosure. In addition, the description of function and structure of the common knowledge can be omitted for clarity and conciseness.

The terms and expressions used in the description and claims below are not limited to their lexicographical meaning but are used only by the inventor to enable the clear and consistent understanding of the present disclosure. Therefore, it should be apparent to those skilled in the art that the following description of the various embodiments of the present disclosure is provided only for the purpose of the illustration without limiting the present disclosure as defined by the appended claims and their equivalents.

It will be understood that, unless specifically stated, the singular forms “one”, “a”, and “said” used herein may also include the plural form. Thus, for example, “component surface” refers to one or more such the surfaces.

The terms “includes” and “may include” mean the presentation of the corresponding disclosed functions, operations, or components that can be used in various embodiments of the present disclosure, but do not limit the presentation of one or more additional functions, operations, or features. In addition, it should be understood that the terms “including” or “having” may be interpreted to mean certain features, numbers, steps, operations, components, assemblies or combinations thereof, but should not be interpreted to exclude the possibility of the existence of one or more of other features, numbers, steps, operations, components, assemblies and/or combinations thereof.

The term “or” as used in various embodiments of the present disclosure includes any listed term and all the combinations thereof. For example, “A or B” may include “A”, may include “B”, or may include both “A and B”.

Unless defined differently, all terms as used in the present disclosure (including technical or scientific terms) have the same meanings as understood by those skilled in the area as described in the present disclosure. As common terms defined in dictionaries are interpreted to have meanings consistent with those in the context in the relevant technical field, and they should not be idealized or overly formalized unless expressly defined as such in the present disclosure.

The technical solutions of the embodiments of the present disclosure may be applied to various communication systems, such as Global System for Mobile Communications (GSMs), Code Division Multiple Access (CDMA) systems, Wideband Code Division Multiple Access (WCDMA) systems, General Packet Radio Service (GPRS), Long Term Evolution (LTE) systems, LTE Frequency Division Duplex (FDD) systems, LTE Time Division Duplex (TDD) systems, Universal Mobile Telecommunication Systems (UMTS), Worldwide Interoperability for Microwave Access (WiMAX) communication systems, the 5th Generation (5G) systems or New Radio (NR), and so on. In addition, the technical solutions of the embodiments of the present disclosure may be applied to communication technology for the future.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

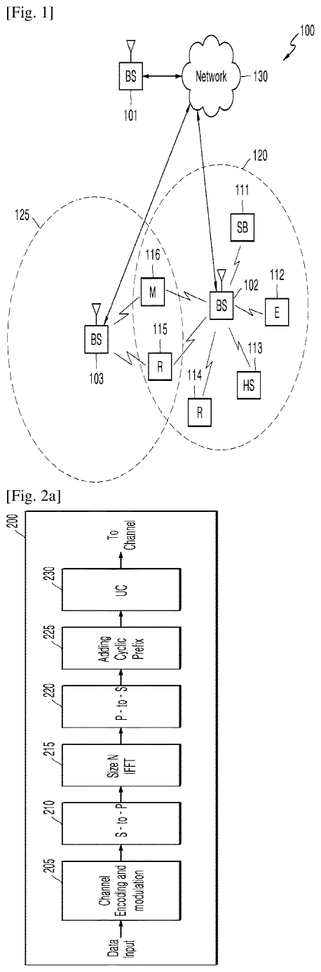

FIG. 1 illustrates an example wireless network 100 according to an embodiment of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a commonly considered fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

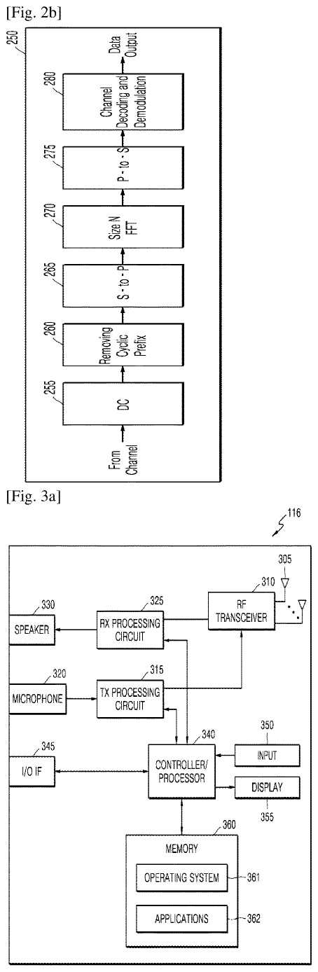

FIGS. 2a and 2b illustrate example wireless transmission reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

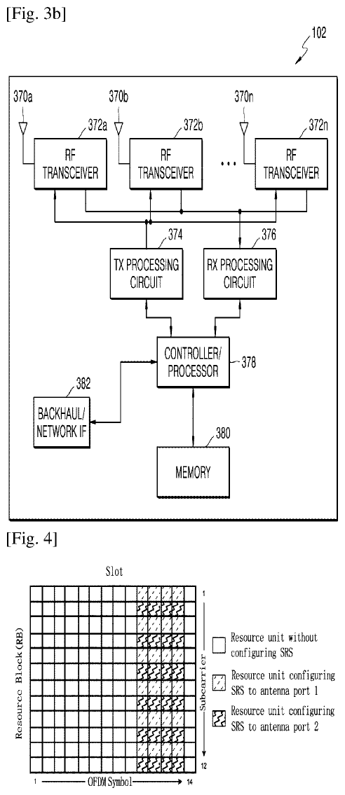

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

One of the primary means for ensuring communication rate and reliability in the current wireless communication systems is processing a signal or adjusting a transceiving policy through channel state information (CSI) at both transmitting and receiving terminals. For example, at a transmitting terminal, such as gNB shown in FIG. 3B, a transmission signal is pre-coded, and a power and a modulation coding scheme of the transmission signal are adjusted, and at a receiving terminal, such as the UE shown in FIG. 3a, channel equalization is performed on a reception signal, different transceiving beams are selected and the like, so as to eliminate the influence of the channel on the signal as much as possible. Only as an example rather than a limitation, the channel state information may be at least one of: a channel response, a reference signal receive power (RSRP), a signal to interference and noise ratio (SINR), a channel quality indicator (CQI), a precoding matrix indicator, a layer indicator (LI), a rank indicator (RI), and a resource indicator. However, due to complex and changeable characteristics of wireless channels in a time domain, frequency domain, and space domain, one of the biggest challenges of the wireless communication is how to accurately obtain the channel state information. At present, the prosperity and development of smart mobile devices and related applications have stimulated users' demands for faster speeds and lower latency in wireless communication. These demands have promoted wireless communication networks to evolve towards wider frequency bands and more antennas, and accordingly, resources required by and difficulty in acquisition of the channel state information have also increased. In order to further improve spectral efficiency of wireless communication systems, at present, how to efficiently acquire channel state information is regarded as one of the key challenges of future wireless communication systems both in industry and academia.

In the existing wireless communication systems, the method of ensuring communication quality by eliminating the influence of the channel on the signal requires to know channel state information of each antenna for information transmission on any time point and on any frequency point at a receiving terminal and/or a transmitting terminal. In general, the channel state information of the present disclosure is a comprehensive influence of an entire wireless communication link on an amplitude and phase of a signal on all physical resources occupied by its transmission. Here, the physical resource may be time domain physical resources, frequency domain physical resources, space domain physical resources, etc. In general, the antenna of the present disclosure is a generalized antenna representing a space domain resource occupied by signal transmission, which may be a physical antenna element, an antenna array containing a plurality of physical antenna elements, a beam, an antenna port, a precoding matrix of a transmitting terminal, or the like; a time point represents a time domain resource occupied by signal transmission, is a time unit taking a predetermined time interval as minimum granularity, and may be a wireless frame, a sub-frame, a slot, a symbol, or the like, for example, only as an example rather than a limitation, a time point in LTE and NR may be a slot containing 14 OFDM symbols; a frequency point represents a frequency domain resource occupied by signal transmission, is a frequency unit taking a predetermined frequency range as minimum granularity, may be a sub-band, a bandwidth part (BWP), a subcarrier, or the like, for example, only as an example rather than a limitation, a frequency point in LTE and NR may be a subcarrier containing a frequency range of 15 kHz.

In general, transmission of information will occur on a continuous time point and frequency point greater than one. In the existing wireless communication systems, a method of acquiring channel state information for a certain antenna is to select part of frequency points and/or points in time in its operating frequency band and operating time with a certain regularity to transmit a reference signal (RS), and estimate wireless channel state information accordingly. The wireless communication system may transmit a non-reference signal, such as a data signal and/or a control signal, on other frequency points on the operating frequency band and/or other points in time during operating hours. The reference signal is a transmission signal formed by a generation sequence, and its content and a time point and frequency point on which the transmission is located are shared by both receiving and transmitting terminals. The reference signal may also be called a pilot signal, a training signal, etc.

At present, the most widely used wireless communication systems are cellular communication systems based on the 3rd Generation Partnership Project (3GPP) protocol, such as 4G communication systems such as LTE (Long Term Evolution), LTE-A (LTE-Advanced) and the like, and 5G communication systems such as NR etc. In LTE-A and NR systems, channel state information may be acquired through a transmitted channel state information reference signal (CSI-RS), a sounding reference signal (SRS), a demodulation reference signal (DM-RS), or the like. Specifically, before transmitting a reference signal, one of the receiving and transmitting terminals first determines a resource set PRS consisting of physical resources occupied by the reference signal, and informs the other terminal of the PRs through a data signal and/or a control signal. The resource set PRS may include information on positions of physical resources in the time domain and the frequency domain. For example, in NR systems, a minimum unit of a time domain resource is an OFDM symbol, and several OFDM symbols may form a slot; a minimum unit of a frequency domain resource is a subcarrier, several subcarriers may form a resource block (RB), and several RBs arranged in the frequency domain from a sub-band or a bandwidth part; a resource consisting a subcarrier in a frequency domain and an OFDM symbol in a time domain is a resource element of a minimum granularity of a system. Based on this, the resource set PRS will specifically indicate the RE occupied by the reference signal in the NR system.

The communication system will determine to insert a mode and density of the reference signal into the time domain and the frequency domain according to changing trends of both the time and frequency domains, depending on different application scenarios. For example, in the NR, the communication system may at least configure partial subcarriers in an RB for a subband or bandwidth part in the frequency domain to place the reference signal corresponding to an antenna port, and ensure that at least one subcarrier is configured for each antenna port to place the reference signal. If the system is configured with multiple RBs, subcarriers of different antenna ports may also be placed on different RBs. In the time domain, the communication system will take a slot as a minimum unit, and slots required for placing the reference signal are configured periodically or aperiodically.

FIG. 4 illustrates a schematic diagram of SRS resource configuration supporting two antenna ports according to an exemplary embodiment of the present disclosure. More specifically, taking an uplink reference signal SRS in a 3GPP NR protocol as an example, FIG. 4 illustrates the SRS resource configuration supporting two antenna ports (i.e., an antenna port 1 and an antenna port 2). As illustrated in FIG. 4, an RB consists of 12 subcarriers in the frequency domain, and a slot consists of 14 OFDM symbols in the time domain. In the schematic diagram, SRS configured to the antenna port 1 occupies 10 to 13 OFDM symbols in the slot, and occupies subcarriers 1, 3, 5, 7, 9 and 11 in the frequency domain; SRS configured to the antenna port 2 also occupies 10 to 13 OFDM symbols in the slot, but occupies subcarriers 2, 4, 6, 8, 10 and 12 in the frequency domain. In the case of the reference signal resource configuration as an example in FIG. 4, about 28.57% of the physical resources are used for SRS overhead.

After the resource set PRS consisting of the physical resources occupied by the reference signal is determined, the transmitting terminal may transmit the reference signal on the physical resources determined by the PRS, and the receiving terminal may receive the reference signal at the physical resources designated according to the PRS. The channel state information acquired by this method may include: channel state information on a time point where the reference signal is located and on first threshold (M) points in time before and after it in the time domain; channel state information on a frequency point where the reference signal is located and on second threshold (N) frequency points before and after it in the frequency domain; and channel state information on an antenna where the reference signal is located in the space domain. The reference signal is distributed in a certain mode and density on at least one of the time domain physical resource, the frequency domain physical resource and the space domain physical resource.

However, a reference signal overhead of the channel state information acquisition method is relatively large and needs to be further improved.

In the present disclosure, the known channel state information is defined as the channel state information of the physical resource where the reference signal is located, the channel state information of the physical resource in vicinity of the physical resource where the reference signal is located is the knowable channel state information (it should be noted that the vicinity here may represent the above-described N frequency points before and after, or M points in time before and after, but may not be limited hereto), the channel state information of the physical resource other than the physical resource where the reference signal is located is unknowable channel state information, and the unknown channel state information is knowable channel state information and/or unknowable channel state information.

More specifically, only as an example rather than a limitation, the channel state information on the frequency point and the time point occupied by the reference signal configured on a certain antenna may be the known channel state information, the channel state information on the N frequency points before and after the frequency point occupied by the reference signal and the M points in time before and after the time point occupied by the reference signal on the same antenna may be the knowable channel state information, the channel state information on other points in time and frequency points and the channel state information on the antenna on which no reference signal is configured, other than the known channel state information and the knowable channel state information on the same antenna, may be the unknowable channel state information, and the knowable channel state information and/or the unknowable channel state information may be the unknown channel state information.

When the known channel state information is distributed separately on physical resources of one dimension, for example, when it is distributed on physical resources in the time domain, the known channel state information is the channel state information of a reference signal configured on a single antenna, a single frequency point, and multiple different points in time.

Correspondingly, the unknown channel state information may be divided into two parts, one part is the channel state information on a time point on which no reference signal is transmitted on the same antenna and frequency point as the known channel state information, and the other part is channel state information on all frequency points and points in time on an antenna different from the known channel state information.

Similarly, when the known channel state information is distributed simultaneously on physical resources of two dimensions, for example, when it is distributed on physical resources in the time domain and the frequency domain, the known channel state information is the channel state information of a reference signal configured on a single antenna, multiple different points in time and multiple different frequency points.

Correspondingly, the unknown channel state information may be divided into two parts, one part is the channel state information on a frequency point and time point on which no reference signal is transmitted on the same antenna as the known channel state information, and the other part is channel state information on all frequency points and points in time on an antenna different from the known channel state information; similarly, when the known channel state information is distributed simultaneously on physical resources of three dimensions, the known channel state information is the channel state information of a reference signal configured on multiple different antennas, multiple different points in time and multiple different frequency points.

Correspondingly, the unknown channel state information may be divided into two parts, one part is the channel state information on a frequency point and time point on which no reference signal is transmitted on the same antenna as the known channel state information, and the other part is channel state information on all frequency points and points in time on an antenna different from the known channel state information.

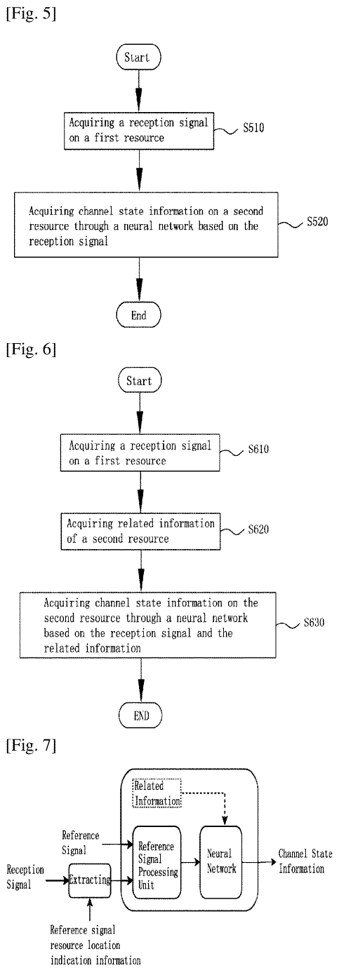

FIG. 5 illustrates a flowchart of a channel state information acquisition method according to an embodiment of the present disclosure.

Referring to FIG. 5, in step S510, a reception signal on a first resource may be acquired. Here, the first resource may be used for the reference signal, that is to say, the first resource may correspond to the above physical resource where the reference signal is located. More specifically, only as an example rather than a limitation, the signal may be received by a receiver of a communication node, and the reception signal on the first resource may be extracted from the received signal based on reference signal resource location indication information.

In addition, only as an example rather than a limitation, the communication node may be a base station, e.g., a macro base station, micro base station, pico base station and femto base station for wireless access networks, a backhaul base station for unlimited backhaul, and a base stations that integrates access and backhaul functions simultaneously, etc.; the communication node may further be a user apparatus, e.g., a mobile phone, a laptop computer, a tablet computer, a smart watch, etc. having a wireless access function.

In addition, only as an example rather than a limitation, when the communication node is a base station, the reference signal resource location indication information may be determined by the base station itself, and when the communication node is a user apparatus, the reference signal resource location indication information may be configured by the base station. In addition, the reference signal is known to the communication node.

In step S520, channel state information which is on a second resource may be acquired through a neural network based on the reception signal, wherein the neural network includes a plurality of cascaded sub-neural networks, wherein each of the sub-neural networks is used for acquiring the channel state information which is on partial resource of the second resource. More specifically, each sub-neural network may further be used for acquiring channel state information on at least one of a time domain resource, a frequency domain resource and a space domain resource of the second resource.

More specifically, only as an example rather than a limitation, step S520 may further include: acquiring the channel state information which is on the first resource based on the reception signal, and acquiring the channel state information which is on the second resource through the neural network based on the channel state information which is on the first resource. Here, since the first resource corresponds to the above physical resource where the reference signal is located, the channel state information which is on the first resource is also the above known channel state information.

In addition, more specifically, only as an example rather than a limitation, step S520 may further include: acquiring the channel state information which is on the first resource based on the reception signal; acquiring channel state information which is on a third resource based on the channel state information which is on the first resource; and acquiring the channel state information which is on the second resource through the neural network based on the channel state information which is on the third resource, or based on the channel state information which is on the first resource and the channel state information which is on the third resource. Here, the third resource may correspond to the above physical resource in vicinity of the physical resource where the reference signal is located, thus, the channel state information which is on the third resource is the above knowable channel state information.

On this basis, only as an example rather than a limitation, the second resource may include at least one of following: the second resource different from the first resource; the second resource different from the first resource and the third resource; the second resource including the first resource and resources other than the first resource; the second resource including the first resource, the third resource and resources other than the first resource and the third resource; a time domain offset between the second resource and the first resource being greater than a first threshold; a frequency domain offset between the second resource and the first resource being greater than a second threshold; and the second resource whose space domain resource is different from a space domain resource of the first resource.

Here, only as an example rather than a limitation, the channel state information on the first threshold frequency points before and after the frequency point where the reference signal is located, and the channel state information on the second threshold points in time before and after the time point where the reference signal is located may both be the knowable channel state information. Values of the first threshold and the second threshold may be determined by a coherence bandwidth and coherence time of a channel in an environment where the current system is located. In addition, in order to ensure accuracy of channel estimation, the values of the first threshold and the second threshold may be much smaller than the coherence bandwidth and coherence time of the system.

In addition, only as an example rather than a limitation, the channel state information acquisition method according to the exemplary embodiment of the present disclosure may further acquire related information of the second resource, thus, the step of acquiring the channel state information which is on the second resource through the neural network based on the reception signal may include: acquiring the channel state information which is on the second resource through the neural network based on the reception signal and the related information. Only as an example rather than a limitation, the related information may be a physical resource position where the known channel state information is located and/or a physical resource position where the unknown channel state information is located.

In addition, only as an example rather than a limitation, in the case where the first resource corresponds to the above physical resource where the reference signal is located, the step of acquiring the channel state information which is on the second resource through the neural network based on the reception signal and the related information may include: acquiring the channel state information which is on the second resource through the neural network based on the reference signal, the reception signal and the related information.

In addition, only as an example rather than a limitation, the number of activated sub-neural networks in the plurality of sub-neural networks may be determined based on at least one of a processing delay requirement for acquiring the channel state information, an energy consumption requirement for acquiring the channel state information, an accuracy requirement for acquiring the channel state information, and a resource dimension of the second resource, wherein the resource dimension of the second resource is included in the related information of the second resource.

Only as an example rather than a limitation, an input of the neural network may be determined according to subsequent requirements of the neural network, such as the known channel state information and/or the knowable channel state information and the related information, or the reception signal and the reference signal on the first resource and the related information are directly input.

Thus, an input of each sub-neural network is an output of an upper level, or the output of the upper level and the related information. When the sub-neural network is not a last sub-neural network in the neural network, the channel state information output thereby may be a channel response; when the sub-neural network is the last sub-neural network in the neural network, the channel state information output thereby may be at least one of: a channel response, a reference signal receive power, a signal to interference and noise ratio, a channel quality indicator, a precoding matrix indicator, a layer indicator, a rank indicator and a resource indicator.

In addition, each sub-neural network may include an information processing unit and at least one neural network layer, wherein the information processing unit is used to convert the input into data available to the neural network layer. In addition, the information processing unit may convert the input into the data available to the neural network layer through at least one of numerical mapping, elements merging, and positional encoding. Contents related to the neural network will be described in more detail later.

According to the exemplary embodiment of the present disclosure, by using the neural network including the plurality of cascaded sub-neural networks, the communication node may be enabled to accurately acquire the channel state information through reference signals (e.g., sounding reference signals, channel state information reference signals, demodulation reference signals, etc.) with lower density and/or lower number distribution, thereby reducing a resource overhead of the reference signal, and improving a resource utilization rate and performance of the wireless communication system; According to the physical resource dimension where the channel state information that needs to be acquired is located, different sub-neural networks are cascaded to obtain the channel state information that needs to be acquired on all the physical resource dimensions, so that the communication node may accurately acquire the channel state information through multiple lightweight sub-neural networks, thereby reducing storage resources required to store neural network parameters and computing resources required to run the neural network. Meanwhile, each of lightweight sub-neural network models may be trained independently, which greatly reduces difficulty in training the neural network model.

FIG. 6 illustrates a flowchart of a channel state information acquisition method according to an embodiment of the present disclosure.

Referring to FIG. 6, in step S610, a reception signal on a first resource may be acquired. Here, the first resource may be used for the reference signal, that is to say, the first resource may correspond to the above physical resource where the reference signal is located.

More specifically, only as an example rather than a limitation, the signal may be received by a receiver of a communication node, and the reception signal on the first resource may be extracted from the received signal based on reference signal resource location indication information. In addition, only as an example rather than a limitation, the communication node may be a base station, e.g., a macro base station, micro base station, pico base station and femto base station for wireless access networks, a backhaul base station for unlimited backhaul, and a base stations that integrates access and backhaul functions simultaneously, etc.; the communication node may further be a user apparatus, e.g., a mobile phone, a laptop computer, a tablet computer, a smart watch, etc. having a wireless access function.

In addition, only as an example rather than a limitation, when the communication node is a base station, the reference signal resource location indication information may be determined by the base station itself, and when the communication node is a user apparatus, the reference signal resource location indication information may be configured by the base station. In addition, the reference signal is known to the communication node.

In step S620, related information of the second resource may be acquired. Here, the related information may be associated with the known channel state information and/or the unknown channel state information. Only as an example rather than a limitation, the related information may be at least one of a physical resource position where the known channel state information is located (i.e., the reference signal resource position indication information) and a physical resource position where the unknown channel state information is located.

More specifically, for example, the related information may be at least one of subcarrier frequency domain position indication occupied by the reference signal, transmission symbol time domain position indication and indication of the antenna where the transmission is located; and the related information may further be at least one of subcarrier frequency domain position indication that is not occupied by the reference signal and needs to be acquired, symbol time domain position indication that is not occupied by the reference signal and needs to be acquired and indication of the antenna where no reference signal is transmitted and that needs to be acquired.

In step S630, the channel state information which is on the second resource may be acquired through the neural network based on the reception signal and the related information. Here, only as an example rather than a limitation, step S630 may further use the reference signal to acquire the channel state information which is on the second resource, that is, acquire the channel state information which is on the second resource through the neural network based on the reference signal, the reception signal and the related information.

More specifically, only as an example rather than a limitation, step S630 may further include: acquiring the channel state information which is on the first resource based on the reception signal; acquiring the channel state information which is on the second resource through the neural network based on the channel state information which is on the first resource and the related information. Here, since the first resource corresponds to the above physical resource where the reference signal is located, the channel state information which is on the first resource is also the above known channel state information.

More specifically, only as an example rather than a limitation, step S630 may further include: acquiring the channel state information which is on the first resource based on the reception signal; acquiring channel state information which is on a third resource based on the channel state information which is on the first resource; and acquiring the channel state information which is on the second resource through the neural network based on the channel state information which is on the third resource and the related information, or based on the channel state information which is on the first resource, the channel state information which is on the third resource and the related information. Here, the third resource may correspond to the above physical resource in vicinity of the physical resource where the reference signal is located, thus, the channel state information which is on the third resource is the above knowable channel state information.

On this basis, only as an example rather than a limitation, the second resource may include at least one of following: the second resource different from the first resource; the second resource different from the first resource and the third resource; the second resource including the first resource and resources other than the first resource; the second resource including the first resource, the third resource and resources other than the first resource and the third resource; a time domain offset between the second resource and the first resource being greater than a first threshold; a frequency domain offset between the second resource and the first resource being greater than a second threshold; and the second resource whose space domain resource is different from a space domain resource of the first resource.

Here, the neural network may include a plurality of cascaded sub-neural networks, wherein at least one of the plurality of sub-neural networks is used for acquiring the channel state information which is on partial resource of the second resource.

According to the exemplary embodiment of the present disclosure, by using the related information, the neural network may be enabled to acquire priori information implied in the related information, so that output accuracy of the neural network is improved, and the neural network may be enabled to flexibly adjust a range of its output channel state information through the resource position where the unknown channel state information is located.

The channel state information acquisition method according to the exemplary embodiment of the present disclosure will be described in more detail with reference to FIG. 7 below.

FIG. 7 illustrates a schematic diagram of a channel state information acquisition method according to an embodiment of the present disclosure.

Referring to FIG. 7, first, a reception signal on a first resource may be extracted from the received signal based on the reference signal resource position indication information, and then information input to the neural network may be acquired by a reference signal processing unit based on the reception signal on the first resource and the reference signal.

Here, the reference signal processing unit may be formed by hardware, software or a combination thereof, which may be configured by those skilled in the art according to the actual needs. The reference signal processing unit may generate information required by the subsequent neural networks, and the information is used to acquire the channel state information which is on the second resource. The reference signal processing unit may enable the receiver of the communication node to be flexibly compatible with neural networks having different capabilities, so as to facilitate it to update or upgrade the neural network.

In some examples, if the neural network may compute the channel state information which is on the second resource through the knowable channel state information, the reference signal processing unit may use the reference signal and the reception signal on the first resource to generate the knowable channel state information, for example, the reference signal processing unit may obtain the known channel state information through an estimation algorithm (only as an example rather than a limitation, least squares, minimum mean square error, etc.), and obtain the knowable channel state information through interpolation. The reference signal processing unit may further directly obtain the knowable channel state information from the reference signal and the reception signal on the first resource through a neural network.

In some other examples, if the neural network may compute the channel state information which is on the second resource through the known channel state information, the reference signal processing unit may use the reference signal and the reception signal on the first resource to generate the known channel state information, for example, the reference signal processing unit may obtain the known channel state information through an estimation algorithm or neural network. In some other examples, if the neural network may compute the channel state information which is on the second resource according to the reference signal and the reception signal on the first resource, the reference signal processing unit may directly use its input (i.e., the reference signal and the reception signal on the first resource) as the output directly without extra processing.

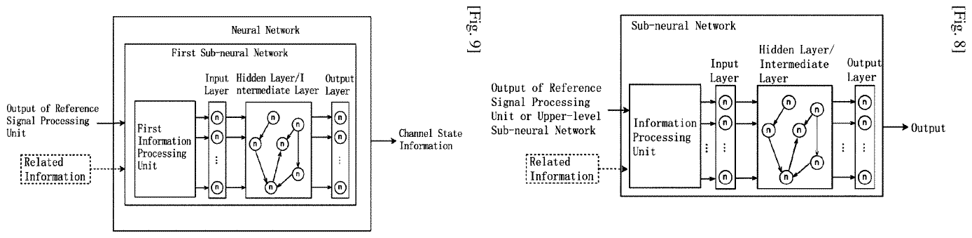

The neural network according to the exemplary embodiment of the present disclosure will be described in more detail with reference to FIG. 8 below.

FIG. 8 illustrates a schematic diagram of a sub-neural network according to an embodiment of the present disclosure.

Referring to FIG. 8, an information processing unit may convert an input of a sub-neural network into at least one of data vector, a matrix or a tensor computable by the sub-neural network. A neural network layer may be at least one of an input layer, a hidden layer/intermediate layer and an output layer as illustrated in FIG. 8.

In addition, each neural network layer can be composed of multiple neurons n, and at least one activation function may be used to activate neurons, only as an example rather than a limitation, such as tanh function, ReLU function, eLU function, seLU function, ceLU function, preLU function, geLU function, LeakyReLU function, Sigmoid function, Softmax function, Softplus function, etc. Each neural network layer may perform operation on its input data to realize functions such as matrix transformation, data dimension reduction, data feature extraction, data feature combination, etc. Only as an example rather than a limitation, multiple neural network layers may be connected in series or in parallel to form different neural network structures, including but not limited to multi-layer perceptron (MLP), multi-layer perceptron mixer (MLP-mixer), convolutional neural network (CNN), deep neural network (DNN), recurrent neural network (RNN), restricted Boltzmann machine (RBM), deep belief network (DBN), bidirectional recursive deep neural network (BRDNN), generative adversarial network (GAN), transformer network and so on.

In addition, the information processing unit may also process related information (such as merging, position encoding, etc., which will be described below), so that the neural network will obtain priori information implied in the related information (such as relative positions of the known channel state information and the unknown channel state information, a distribution structure of the physical resources where the known channel state information is located, a distribution structure of the physical resources where the unknown channel state information is located, etc.), to assist the neural network to improve the accuracy and flexibility of acquiring the channel state information. Here, the related information may be associated with the known channel state information and/or the unknown channel state information.

Only as an example rather than a limitation, the related information may be at least one of a physical resource position where the known channel state information is located (i.e., the reference signal resource position indication information) and a physical resource position where the unknown channel state information is located.

More specifically, for example, the related information may be at least one of subcarrier frequency domain position indication occupied by the reference signal, transmission symbol time domain position indication and indication of the antenna where the transmission is located; and the related information may further be at least one of subcarrier frequency domain position indication that is not occupied by the reference signal and needs to be acquired, symbol time domain position indication that is not occupied by the reference signal and needs to be acquired and indication of the antenna where no reference signal is transmitted and that needs to be acquired.

When the communication node is a base station, the related information may be determined by the communication node itself; when the communication node is a user apparatus, a determination method of the related information may be: determining according to signaling acquired by the communication node, wherein the signaling may be higher layer signaling, MAC signaling, downlink control information, side-link control information, etc.

In an exemplary embodiment, the information processing unit may only convert an output of a reference signal processing unit or an output of an upper level sub-neural network into at least one of vectors, matrices, and tensors for calculation of the neural network layer without using the related information.

Only as an example rather than a limitation, taking the reference signal processing unit outputting the known channel state information as an example, a set consisting of the known channel state information is defined as C_{RS}.

First, the known channel state information is processed by a numerical mapping method (e.g., normalization, standardization, etc.) to make its numerical scale or distribution suitable for the calculation of the neural network. More specifically, taking Min-max standardization as an example, maximum values max (C_{RS}) and minimum values min (C_{RS}) of all elements in C_{RS} may be calculated, respectively, and then following processing

$$\text{?} = \frac{{x}_{n} - min ( {C}_{R S} )}{max ( {C}_{R S} ) - min ( {C}_{R S} )}$$

may be performed on each element ∀×ₙ∈ vec(C_{RS}) in C_{RS}. After performing the above numerical mapping, the set [symbol] consisting of the processed elements [symbol] may be converted into at least one of the vectors, matrices, and tensors corresponding to the input size of the neural network layer. In an embodiment, the information processing unit may merge an output of the reference signal processing unit or an output of the upper level sub-neural network with the related information, and convert the merged information into at least one of vectors, matrices, and tensors for calculation of the sub-neural network.

Only as an example rather than a limitation, taking the reference signal processing unit outputting the known channel state information as an example, a set of the related information is defined as Q, and first the numerical mapping is performed on the known channel state information and the related information to obtain [symbol] and \hat{Q}. Then elements in [symbol] and \hat{Q} may be converted into at least one of vectors, matrices, and tensors and merged.

In an embodiment, the information processing unit may position-encode an output of the reference signal processing unit or an output of the upper level sub-neural network according to the related information, and convert the position-encoded information into at least one of vectors, matrices, and tensors for calculation of the sub-neural network.

Alternatively, the position encoding may be a process of adding and/or multiplying information with a codeword in a predetermined codebook. Only as an example rather than a limitation, taking the reference signal processing unit outputting the known channel state information as an example, performing position encoding with a codebook may include a following process: first, a set C_{RS} consisting of the known channel state information is processed according to a numerical mapping method to obtain a set [symbol] , in which several elements [symbol] on which the numerical mapping is performed; subsequently, a codebook of the position encoding is obtained according to following equation 1.

$${f ( n )}^{( i )} : = \{ \begin{matrix}sin ( n / {N}^{2 i / d} ) ) if i is an even number \\ cos ( n / {N}^{2 i / d} ) ) if i is an odd number\end{matrix} \qquad [ equation 1 ]$$

where n denotes positions of physical resources (such as a time domain, a frequency domain and a space domain) where the channel state information is located, d denotes a physical resource dimension of the channel state information, N is an arbitrary positive integer greater than a number of elements included in the set [symbol] , and i denotes an index of a physical resource dimension.

Subsequently, the known channel state information elements [symbol] are position-encoded by the equation [symbol] = [symbol] +[f(n)⁽⁰⁾, f(n)⁽¹⁾, . . . , f(n)^{(d)}] to obtain a set [symbol] ; finally, a set [symbol] , consisting of the processed elements [symbol] may be converted into at least one of the vectors, matrices, and tensors corresponding to the input size of the neural network layer.

Alternatively, the position encoding may further be a process of inputting information to a neural network for position encoding. Only as an example rather than a limitation, taking the reference signal processing unit outputting the known channel state information as an example, performing position encoding with a neural network may include a following process: first, a set C_{RS} consisting of the known channel state information is processed according to a numerical mapping method to obtain a set [symbol] in which several elements [symbol] on which the numerical mapping is performed; subsequently, a position-encoded codebook α(n) is output by using a multi-layer perceptron (e.g., a neural network containing multiple cascaded fully connected layers), and the known channel state information [symbol] is position-encoded through an equation [symbol] = [symbol] +α(n) to obtain a set [symbol] , wherein the number of output neurons of the multi-layer perceptron may be greater than or equal to the number of elements in the set [symbol] , a weight of the multi-layer perceptron may be trained together with the neural network for acquiring the channel state information; finally, a set [symbol] consisting of the processed elements [symbol] may be converted into at least one of the vectors, matrices, and tensors corresponding to the input size of the neural network layer.

Only as an example rather than a limitation, the neural network may be formed by cascading the above at least one sub-neural network. Each sub-neural network contains correlation between the channel state information on a specific physical resource dimension, and according to this correlation, each sub-neural network may obtain unknown channel state information on the corresponding physical resource dimension through a few reference signals and/or channel state information distributed on the specific physical resource dimension according to this correlation.

Only as an example rather than a limitation, channel state information on other antennas may be obtained based on the channel state information on a few antennas by capturing spatial correlation of the antennas to avoid system interruption caused by antenna switching, and further transmit the reference signal only on partial antennas. In the frequency domain, it surpasses traditional constraints of channel state information interpolation between adjacent subcarriers, and promotes extrapolation of the channel state information between multiple bandwidth parts, so that the reference signal may be transmitted only on some bandwidth parts, and channel reciprocity in a frequency division duplex system may also be utilized. Within a time range, influence of Doppler effect on the reference signal may be effectively captured, so that the channel state information may be accurately reconstructed in a high-speed scene, and the channel reciprocity in a time division duplex system may also be improved.

In addition, this implementation enables the receiver of the communication node to further flexibly adjust the number of the sub-neural networks used according to the channel state information acquisition requirement, wherein, the channel state information acquisition requirement may be at least one of a processing delay requirement for acquiring the channel state information, an energy consumption requirement for acquiring the channel state information, an accuracy requirement for acquiring the channel state information, and a physical resource dimension of the channel state information. For example, when the receiver of the communication node needs to acquire channel state information on a physical resource dimension (one of a time domain, a frequency domain, or a space domain), the receiver of the communication node may activate a sub-neural network in the neural network; when the receiver of the communication node needs to acquiring channel state information on two physical resource dimensions (one of a time domain and frequency domain, a time domain and space domain, and a frequency domain and space domain), the receiver of the communication node may activate a sub-neural network or two sub-neural networks in the neural network; when the receiver of the communication node needs to acquire channel state information on three physical resource dimensions (a time domain, frequency domain, and space domain), the receiver of the communication node may activate a sub-neural network, two sub-neural networks, or three sub-neural networks in the neural network.

Under normal circumstances, the requirement for the channel state information acquisition may be determined by the communication node itself. In particular, when the communication node is a user apparatus, a determination method for a channel state information processing delay in the channel state information acquisition requirement and a resource dimension where the channel state information that needs to be acquired is located may be: determining according to signaling acquired by the communication node, wherein the signaling may be higher layer signaling, MAC signaling, downlink control information, side-link control information, etc.

In general, all the physical resources of the time domain, the frequency domain and the space domain for transmitting signals are defined to form sets Iₜ, I_{f} and Iₛ, respectively; the physical resources of the time domain, the frequency domain and the space domain where the reference signal is located form sets

$${I}_{t}^{R S} , {I}_{f}^{R S} , and {I}_{s}^{R S} ,$$

respectively; the physical resources of the time domain, the frequency domain and the space domain of the unknown channel state information form sets

$${I}_{t}^{D} , {I}_{f}^{D} , and {I}_{s}^{D} ,$$

respectively. Then, according to the definitions of the known channel state information and the unknown channel state information, it may be known that

$${I}_{t} = {I}_{t}^{R S} ⋃ {I}_{t}^{D} , If = {I}_{f}^{RS} ⋃ {I}_{f}^{D} , Is = {I}_{s}^{R S} ⋃ {I}_{s}^{D} , and$$

$${I}_{t}^{R S} ⋂ {I}_{t}^{D} = ∅ , {I}_{f}^{R S} ∩ {I}_{f}^{D} = ∅ , {I}_{s}^{R S} ⋂ {I}_{s}^{D} = ∅ .$$

FIG. 9 illustrates a schematic diagram of a neural network according to an embodiment of the present disclosure.

As illustrated in FIG. 9, in an exemplary embodiment, a receiver of a communication node may activate a sub-neural network (i.e., a first sub-neural network) to acquire channel state information, and the neural network is formed by a single neural network. This implementation may enable the receiver of the communication node to acquire the required channel state information with lower energy consumption and processing delay.

At this moment, an input of the first sub-neural network is an output of the reference signal processing unit and/or related information, and an output of the first sub-neural network is at least one of the vectors, matrices, and tensors composed of channel state information of a predetermined physical resource dimension.

For example, when the receiver of the communication node activates a single sub-neural network to acquire channel state information on a single time domain physical resource dimension, the output of the neural network may be channel state information on a time point, a frequency point, and an antenna indicated by elements in

$$( {I}_{t} , {I}_{f}^{RS} , {I}_{s}^{R S} ) .$$

For example, when the receiver of the communication node activates a single sub-neural network to acquire channel state information on the time domain and frequency domain physical resource dimensions, the output of the neural network may be channel state information on a time point, a frequency point, and an antenna indicated by elements in

$$( {I}_{t} , {I}_{f} , {I}_{s}^{R S} ) .$$

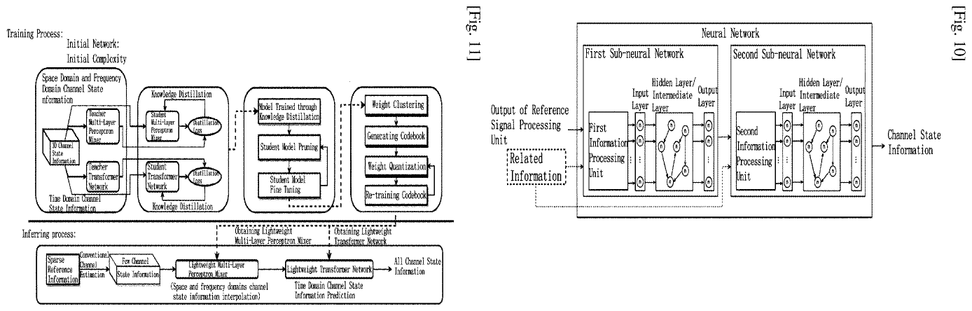

FIG. 10 illustrates a schematic diagram of a neural network according to an embodiment of the present disclosure.

As illustrated in FIG. 10, in an embodiment, a receiver of a communication node may activate two sub-neural networks (i.e., a first sub-neural network, and a second sub-neural network) to acquire channel state information, and the neural network is formed by two cascaded sub-neural networks. This implementation may enable the receiver of the communication node to acquire the channel state information with higher accuracy.

When the receiver of the communication node activates two sub-neural networks to acquire channel state information on two physical resource dimensions, an input of the first sub-neural network is the output of the reference signal processing unit and/or related information, an output of the first sub-neural network is channel state information on a physical resource dimension (e.g., one of the time domain, the frequency domain, and the space domain) in predetermined physical resource dimensions, an input of the second sub-neural network is the output of the first sub-neural network and/or related information, and an output of the second sub-neural network is channel state information on two physical resource dimensions in the predetermined physical resource dimensions.

For example, when the predetermined physical resource dimensions are the time domain and frequency domain physical resources, a first physical resource dimension may be a time domain or a frequency domain, the output of the first sub-neural network may be channel state information on a time point, a frequency point, and an antenna indicated by elements in

$$( {I}_{t} , {I}_{f}^{R S} , {I}_{S}^{R S} ) or ( {I}_{t}^{R S} , {I}_{f} , {I}_{s}^{R S} ) ,$$

and the output of the second sub-neural network is channel state information on a time point, a frequency point, and an antenna indicated by elements in

$$( {I}_{t} , {I}_{f} , {I}_{s}^{R S} ) .$$

When the receiver of the communication node activates two sub-neural networks to acquire channel state information on three physical resource dimensions, an input of the first sub-neural network is the output of the reference signal processing unit and/or related information, an output of the first sub-neural network is channel state information on one (e.g., one of the time domain, the frequency domain and the space domain) or two physical resource dimensions (e.g., one of the time domain and frequency domain, the time domain and space domain, and the frequency domain and space domain) in predetermined physical resource dimensions, an input of the second sub-neural network is the output of the first sub-neural network and/or related information, and an output of the second sub-neural network is channel state information on three physical resource dimensions in the predetermined physical resource dimensions.

For example, the output of the first sub-neural network may be channel state information on a time point, a frequency point, and an antenna indicated by elements in

$$( {I}_{t} , {I}_{f}^{R S} , {I}_{s}^{R S} ) or ( {I}_{t} , {I}_{f} , {I}_{s}^{R S} ) ,$$

and the output of the second sub-neural network is channel state information on a time point, a frequency point, and an antenna indicated by elements in (Iₜ, I_{f}, Iₛ).

FIG. 11 illustrates a schematic diagram of training and inferring of a neural network according to an embodiment of the present disclosure. Here, a structure of the neural network in FIG. 11 is as illustrated in FIG. 10, and formed by cascading two sub-neural networks, but the present disclosure is not limited hereto.

In the embodiment, the receiver of the communication node may be a user apparatus in a 5G-Advance network and equipped with multiple antenna ports. The network configures part of resources within a bandwidth part to the user apparatus for transmitting and receiving reference signals within a period of time interval. The resources configured for the reference signals are distributed in a sparse mode in the frequency domain and time domain, and are distributed on a few antenna ports.

The actual channel state information is represented by a set H, which consists of a subset H_{RS}∈H that contains the actual channel state information (i.e., the known channel state information) on the physical resource where the reference signals are located and a subset H_{nRS}=H\H_{RS} that contains the actual channel state information (i.e., the unknown channel state information) that is not on the physical resources where the reference signals are located. Given a propagation channel that exists in an environment without significant physical changes, there is necessarily a strategy Θ that may accurately map the channel state information in the H_{RS} to the H_{nRS}·Ĥ_{Rs} is the known channel state information that is obtained through an estimation algorithm such as LS, LMMSE or the like, and the mapping strategy may be formulated as:

$$Θ = ( {\hat{H}}_{R s} \vert H ) : {\hat{H}}_{R s} \to {\hat{H}}_{n R s}$$

Where Ĥ_{Rs} is the unknown channel state information obtained through the neural network. The neural network formed by cascading at least one sub-neural network of the present disclosure may enable the obtained Ĥ_{nRs} to be as close to H_{nRS} as possible.

Specifically, in an inferring process as illustrated in FIG. 11, the communication node first obtains a small part of channel state information Ĥ_{Rs} from sparse reference signals (e.g., sounding reference signals, channel state information reference signals, demodulation reference signals, etc.), and then obtains channel state information of the space domain and frequency domain through a lightweight multi-layer perceptron mixer (i.e., the first sub-neural network), that is, outputs the channel state information on the time point, the frequency point, and the antenna indicated by the elements in

$$( {I}_{t}^{R S} , {I}_{f} , {I}_{s} ) ;$$

next, the remaining time domain channel state information is obtained through a lightweight transformer network (i.e., the second sub-neural network), thereby outputting all the channel state information on the time point, the frequency point, and the antenna by the elements in (Iₜ, I_{f}, Iₛ).

Here, the lightweight multi-layer perceptron mixer and the transformer network may be obtained by deep compression training (DCT) method in the training process shown in FIG. 11. The method includes three steps, i.e., knowledge distillation, model pruning, and model quantization. More specifically, the knowledge distillation is a neural network training method based on teacher learning strategies, which may reduce a network complexity by 2 times to 5 times.

In the method, a large-scale teacher network is first trained, after the training is completed, the teacher network is used as a supervisor of a student network, and the lightweight student network is trained by transferring the knowledge of the teacher network. The model pruning may reduce the complexity of the network by compressing the number of weights in each student network, which may reduce the network complexity by 1.8 times to 6.5 times.

After training based on knowledge distillation, multiple rounds of model pruning may be performed on the student network, and weights below a threshold may be removed from the network in each round to reduce a model complexity (these removed weights are regarded as useless weights by the network). After each model pruning iteration, the student network will be re-fine tuned using the method of knowledge distillation.

The model quantization reduces the complexity of each student network by reducing the number of bits occupied by each weight, which may reduce the network complexity by 2.1 times to 3.5 times. A process of model quantization is carried out after the model pruning is completely completed. The process of model quantization is to quantify all the weights of the student network from a format that occupies more bits (e.g., a 32-bit floating-point number) to a format that occupies less bits (e.g., an 8-bit floating-point number).

A K-mean clustering method may be used for each layer in the student network to cluster similar weights into one class to realize quantization. Through the above three steps, the complexity of the network may be reduced by 27 times to 31 times, and an accuracy loss of the compressed network may be compatible with the requirements of the system.

Specifically, an initial network with an initial complexity is first trained by training data (that is, some pre-collected channel state information including three dimensions of time, frequency and space domains), which includes a teacher multi-layer perceptron mixer trained by channel state information of the frequency domain and space domain and a teacher transformer network trained by channel state information of the time domain.

Then, the knowledge distillation is performed on the student multi-layer perceptron mixer through the training data, and a distillation loss obtained by the output of the student multi-layer perceptron mixer and the teacher multi-layer perceptron mixer, and the knowledge distillation is performed on the student transformer network through the training data, and a distillation loss obtained by the output of the student transformer network and the teacher transformer network.

Next, the model pruning and the fine tuning are performed on the student multi-layer perceptron mixer and the student transformer network. The processes of pruning and fine tuning may be iterated multiple times to improve the accuracy of the compressed model. Finally, the fine-tuned student multi-layer perceptron mixer and student transformer network generate a codebook through weight clustering, and quantify the weights to regenerate the codebook.

The processes of the weight quantization and the regeneration of codebook may be iterated multiple times to improve the accuracy of the compressed model. The lightweight multi-layer perceptron mixer and the lightweight transformer network may be obtained through the above three steps.

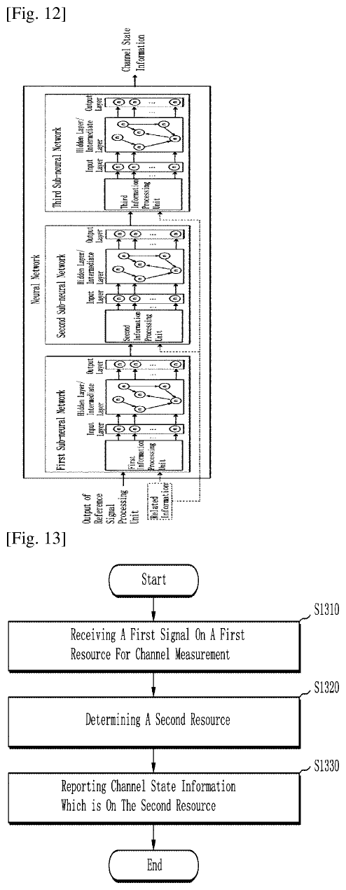

FIG. 12 illustrates a schematic diagram of a neural network according to an embodiment of the present disclosure.

As illustrated in FIG. 12, in an embodiment, a receiver of a communication node may activate three sub-neural networks (i.e., a first sub-neural network, a second sub-neural network, a third sub-neural) to acquire channel state information, and the neural network is formed by three cascaded sub-neural networks.

This implementation may enable the receiver of the communication node to acquire the channel state information with the highest accuracy. At this moment, an input of the first sub-neural network is the output of the reference signal processing unit and/or related information, the output of the first sub-neural network is channel state information on a first physical resource dimension (e.g., one of the time domain, the frequency domain, and the space domain) in predetermined physical resource dimensions, an input of the second sub-neural network is the output of the first sub-neural network and/or related information, an output of the second sub-neural network is channel state information of two dimensions including the first physical resource dimension in the predetermined physical resource dimensions, an input of the third sub-neural network is the output of the second sub-neural network and/or related information, and an output of the third sub-neural network is channel state information on three physical resource dimensions in the predetermined physical resource dimensions.

For example, the output of the first sub-neural network may be channel state information on a time point, a frequency point, and an antenna indicated by elements in

$$( {I}_{t} , {I}_{f}^{R S} , {I}_{s}^{R S} ) ,$$

the output of the second sub-neural network is channel state information on a time point, a frequency point, and an antenna indicated by elements in

$$( {I}_{t} , {I}_{f} , {i}_{s}^{R S} ) or ( {I}_{t} , {I}_{f}^{R S} , {I}_{s} ) ,$$

state information on a time point, a frequency point, and an antenna indicated by elements in (Iₜ, I_{f}, Iₛ).

It should be understood that the number of sub-neural networks included in the above-described neural network and the predetermined physical resource dimensions are only examples rather than limitations, and those skilled in the art may modify and change according to actual needs.

FIG. 13 illustrates a flowchart of a method performed by a first node in a wireless communication system according to an embodiment of the present disclosure.

Here, the first node may be a communication node. The method performed by the first node in the wireless communication system according to the exemplary embodiment of the present disclosure may be applied to a signaling design and the interaction procedure of the communication node of the previous embodiments, so that the communication node may effectively perform measurement and report of the channel state information.

Referring to FIG. 13, in step S1310, a first signal on a first resource for channel measurement may be received.

In step S1320, a second resource may be determined.

Here, the determining of the second resource may include at least one of: determining the second resource based on first information regarding the second resource received from a second node; or determining the second resource based on the first resource.

Only as an example rather than a limitation, the determining of the second resource based on the first resource includes determining the second resource as at least one of: a sub-band, a bandwidth part (BWP) or a frequency band where the first resource is located; and a sub-band, a bandwidth part (BWP) or a frequency band adjacent to the first resource.

The first information may include at least one of: information of a time domain resource, information of a frequency domain resource, information of a space domain resource, or information on a position of the second resource relative to the first resource.

The information on the position of the second resource relative to the first resource may include at least one of: an offset between an initial time domain physical resource of the second resource and an initial time domain physical resource of the first resource; an offset between the initial time domain physical resource of the second resource and an end time domain physical resource of the first resource; an offset between an end time domain physical resource of the second resource and the initial time domain physical resource of the first resource; an offset between the end time domain physical resource of the second resource and the end time domain physical resource of the first resource; an offset between an initial frequency domain physical resource of the second resource and an initial frequency domain physical resource of the first resource; an offset between the initial frequency domain physical resource of the second resource and an end frequency domain physical resource of the first resource; an offset between an end frequency domain physical resource of the second resource and the initial frequency domain physical resource of the first resource; or an offset between the end frequency domain physical resource of the second resource and the end frequency domain physical resource of the first resource.

In step S1330, channel state information which is on the second resource may be reported.

Here, the channel state information which is on the second resource may be measured through following steps: measuring the channel state information which is on the second resource using a first signal through a neural network, wherein the neural network may include a plurality of cascaded sub-neural networks, wherein at least one of the plurality of sub-neural networks is used for acquiring channel state information which is on partial resource of the second resource.

In addition, the method may further include: reporting capability information, wherein the capability information may include at least one of: information of a minimum time domain density of the first signal required for acquiring channel state information, information of a maximum time domain interval of the first signal required for acquiring channel state information, information of a time domain range in which channel state information is acquired, information of a minimum frequency domain density of the first signal required for acquiring channel state information, information of a maximum frequency domain interval of the first signal required for acquiring channel state information, information of a frequency domain range in which channel state information is acquired, or information of a minimum space domain density of the first signal required for acquiring channel state information.

Here, the first node may report the capability information before receiving the first signal on the first resource.

In addition, the method may further include: receiving second information for channel state information measurement and/or report from the second node, wherein the channel state information measurement and/or report may include at least one of: measuring and/or reporting the channel state information which is on the first resource, or measuring and/or reporting the channel state information which is on the second resource.

In addition, the method may further include: determining the channel state information measurement and/or report according to whether the first information is received. Only as an example rather than a limitation, the determining the channel state information measurement and/or report according to whether the first information is received may include at least one of: measuring and/or reporting the channel state information which is on the second resource when the first information is received; and measuring and/or reporting the channel state information which is on the first resource when the first information is not received.

In addition, the method may further include: receiving third information on time when the channel state information is reported from the second node. Only as an example rather than a limitation, the third information may include at least one of: an offset between a time point at which the first node receives the first signal and a latest time point at which the first node reports the channel state information; or an offset between a latest time point at which the first node reports the channel state information which is on the first resource and a latest time point at which the first node reports the channel state information which is on the second resource.

In addition, the method may further include reporting the channel state information which is on the second resource according to at least one of: an interval between subcarriers; the capability reported by the first node; or the channel state information that needs to be reported configured by the second node.

In addition, channel state information which is on the second resource may be acquired through the neural network, wherein the neural network includes a plurality of cascaded sub-neural networks, wherein at least one of the plurality of sub-neural networks is used for acquiring channel state information which is on partial resource of the second resource.

Hereinafter, only as an example rather than a limitation, the method performed by the first node in the wireless communication system as illustrated in FIG. 13 will be described in more details.

According to the embodiment of the present disclosure, the communication node may receive the first signal on the first resource, measure and/or report the channel state information which is on the second resource, and the second resource at least includes a physical resource different from the first resource.

Here, the physical resource may be a time domain physical resource, such as a wireless frame, a sub-frame, a slot, a symbol, or the like; a frequency domain physical resource, such as a sub-band, a bandwidth part (BWP), a physical resource block (PRB), a subcarrier, or the like; and a space domain physical resource, such as an antenna element, an antenna array containing a plurality of physical antenna units, a beam, an antenna port, a precoding matrix at a transmitting terminal, or the like.

In some embodiments, the communication node may be a terminal, the first resource may be a configured physical resource of the first signal, a second resource may be a physical resource corresponding to the channel state information measured and/or reported by the communication terminal, or a physical resource where channel state information that needs to be acquired is located.

The first signal is a basis or reference for the communication node to perform channel state information acquisition, may be a downlink reference signal (such as a channel state information reference signal, a demodulation reference signal, or the like) or a downlink synchronization signal/synchronization signal block (SS/SSB). Taking the first signal being a downlink reference signal (such as a channel state information reference signal) and the communication node being a terminal as an example, the first resource is a configured physical resource of the downlink reference signal, the second resource is a physical resource corresponding to channel state information measured and reported by the communication node according to the downlink reference signal on the first resource, and at least contains an antenna port and/or a sub-band and/or a bandwidth part different from that of the first resource.

In this case, the communication node may receive the first signal on the first resource, and then, according to the received first signal, may acquire and report the channel state information which is on the second resource to an accessed base station or a service cell through a receiver having a channel state information acquisition module (such as the aforementioned receiver including a serial neural network).

Through this embodiment, the wireless communication network may acquire the channel state information which is on the second resource through the downlink signal configured on the first resource, reducing a resource overhead of the downlink signal for acquiring the channel state information, and avoiding switching the communication node on different physical resources in the process of acquiring the channel state information to reduce overhead of the communication node for resource switching, and to thereby further improve resource utilization efficiency of the wireless communication network.

According to an embodiment of the present disclosure, the method of determining the second resource may be determining the second resource based on the first information, wherein the first information (such as higher layer signaling, MAC signaling, downlink control information, side-link control information, etc.) may include at least one of: information of the time domain physical resource where the channel state information is located, such as the wireless frames, subframes, time slots, symbols or the like where the channel state information is located; information of the frequency domain physical resource where the channel state information is located, such as sub-bands, bandwidth parts, physical resource blocks, subcarriers or the like where the channel state information is located; information of the space domain physical resource where the channel state information is located, such as physical antenna units, antenna arrays containing a plurality of physical antenna units, beams, antenna ports, precoding matrices of a transmitting terminal or the like where the channel state information is located; an indicator of physical resource set where the channel state information is located, such as an ID associated with a predefined physical resource set; and a relative positional relationship between the second resource and the first resource, etc.

Here, the relative positional relationship between the second resource and the first resource may be at least one of:
an offset between the initial time domain resource of the second resource and the initial time domain resource of the first resource, for example, the offset is T_{offset0} wireless frames, subframes, slots, symbols or the like, wherein T_{offset0} is a positive integer greater than or equal to 1;
an offset between the initial time domain resource of the second resource and the end time domain resource of the first resource, for example, the offset is T_{offset1} wireless frames, subframes, slots, symbols or the like, wherein T_{offset1} is a positive integer greater than or equal to 1;
an offset between the end time domain resource of the second resource and the initial time domain resource of the first resource, for example, the offset is T_{offset2} wireless frames, subframes, slots, symbols or the like, wherein T_{offset2} is a positive integer greater than or equal to 1;
an offset between the end time domain resource of the second resource and the end time domain resource of the first resource, for example, the offset is T_{offset3} wireless frames, subframes, slots, symbols or the like, wherein T_{offset3} is a positive integer greater than or equal to 1;
an offset between the initial frequency domain resource of the second resource and the initial frequency domain resource of the first resource, for example, the offset is F_{offset0} sub-bands, bandwidth parts, physical resource blocks, subcarriers or the like, wherein F_{offset0} is a positive integer greater than or equal to 1;
an offset between the initial frequency domain resource of the second resource and an end frequency domain resource of the first resource, for example, the offset is F_{offset1} sub-bands, bandwidth parts, physical resource blocks, subcarriers or the like, wherein F_{offset1} is a positive integer greater than or equal to 1;
an offset between an end frequency domain resource of the second resource and the initial frequency domain resource of the first resource, for example, the offset is F_{offset2} sub-bands, bandwidth parts, physical resource blocks, subcarriers or the like, wherein F_{offset2} is a positive integer greater than or equal to 1; or
an offset between the end frequency domain resource of the second resource and the end frequency domain resource of the first resource, for example, the offset is F_{offset3} sub-bands, bandwidth parts, physical resource blocks, subcarriers or the like, wherein F_{offset3} is a positive integer greater than or equal to 1.

In some embodiments, the method of determining the second resource by the communication node may further be obtained implicitly based on the first resource. For example, the first resource has an association relationship with the second resource, and the communication node, according to a predetermined association relationship, may determine the second resource from the first resource, for example, the second resource is subbands, bandwidth parts (such as BWPs), or frequency bands (such as carriers) where the first resource is located; the second resource is sub-bands, bandwidth parts or frequency bands adjacent to the first resource; and the second resource is the sub-bands, the bandwidth parts, or the frequency bands where the first resource is located and the sub-bands, the bandwidth parts or the frequency bands adjacent to the first resource.

In some embodiments, the communication node may further receive second information for the channel state information measurement and/or report from the second node. Here, the second information may be higher layer signaling, MAC signaling, downlink control information, side-link control information, etc. Only as an example rather than a limitation, the channel state information measurement and/or report may include at least one of: measuring and/or reporting the channel state information which is on the first resource, and measuring and/or reporting the channel state information which is on the second resource. Specifically, the second information may include at least one of: indication information of measuring and/or reporting the channel state information which is on the first resource, and indication information of measuring and/or reporting the channel state information which is on the second resource.

In some examples, the communication node is indicated to measure and/or report the channel state information which is on the first resource, and at the moment, the communication node obtains the channel state information of the first resource according to the measurement of the first signal on the first resource, and reports the information.

In some examples, the communication node is indicated to measure and/or report the channel state information which is on the second resource, and at the moment, the communication node obtains the channel state information of the second resource according to the measurement of the first signal on the first resource, and reports the information. Such an embodiment may enable the wireless communication network to be compatible with communication nodes having different channel state information acquisition capabilities, and when the communication node is indicated to measure and report the channel state information which is on the first resource, it is unnecessary to configure the second information to reduce resource consumption.

In some embodiments, the communication node may further determine the channel state information measurement and/or report according to whether the first information is received. Specifically, the communication node measures and/or reports the channel state information which is on the second resource when the first information is received; and the communication node measures and/or reports the channel state information which is on the first resource when the first signaling is not received. Such embodiments reduce the overhead of the signaling.

In some embodiments, the communication node may further receive third information on time when the channel state information is reported. Here, the third information may be higher layer signaling, MAC signaling, downlink control information, side-link control information, etc.

In some examples, the third information may be an offset between a latest time point (such as a symbol, slot, or the like) at which the first node receives the first signal and a latest time point (such as a symbol, slot, or the like) at which the first node reports the channel state information. For example, the offset is T_{offset} symbols or slots, wherein T_{offset} is an integer greater than 0.

In some examples, the third information may further be an offset between the latest time point at which the first node reports the channel state information which is on the first resource and the latest time point at which the first node reports the channel state information which is on the second resource. For example, the latest time point at which the first node reports the channel state information which is on the first resource is Z0+Z1, wherein Z0 is the latest time point at which the first node receives the first signal, and Z1 may be related to an interval between subcarriers, a terminal capability reported by the communication node (e.g., time of beam switching), and channel state information (e.g., channel quality indication, reference signal receive power, or the like) that needs to be reported configured by the communication node. The latest time point at which the communication node reports the channel state information which is on the second resource is Z2=Z0+Z1+8, and the offset of the third information is an integer 8. Such an embodiment may enable the communication node to flexibly adjust calculation resources and algorithms for measuring the channel state information while ensuring that the channel state information is reported within effective time. For example, the receiver of the communication node is a receiver configured with a serial neural network in the aforementioned embodiment, so that it is capable of flexibly selecting the number of sub-neural networks in the serial neural network according to the configured time for measuring the channel state information, so as to save the calculation resources or improve the accuracy of acquiring the channel state information.

In some embodiments, the communication node may determine the time at which the channel state information which is on the second resource is reported according to at least one of: an interval between subcarriers; the capability reported by the first node; and the channel state information that needs to be reported configured by the second node. The time at which the channel state information which is on the second resource is reported may be an offset T_{offset} between a latest time point (such as a symbol, slot, or the like) at which the first node receives the first signal and a latest time point (such as a symbol, slot, or the like) at which the first node reports the channel state information. For example, when the interval between subcarriers is u, T_{offset}=x, when the interval between subcarriers is increased to 2u without changing other conditions, duration of each symbol is decreased, and the offset needs to be increased accordingly; when the capability reported by the first node is that A symbols are required to complete the acquisition of the channel state information, the T_{offset} should not be less than A, that is, T_{offset}≥A; and when the channel state information that needs to be reported configured by the second node is the channel quality indication, the first node takes a short time to calculate, and the offset T_{offset} is smaller, and when the channel state information that needs to be reported configured by the second node is the precoding matrix indication, the first node takes a long time to calculate, and a larger offset T_{offset} is required. Such an embodiment may enable the communication node to flexibly adjust the calculation resources and algorithms for measuring the channel state information while ensuring that the channel state information is reported within effective time, and reduce the overhead of the signaling.

According to an embodiment of the present disclosure, the communication node may report the acquired channel state information to the accessed base station.

In addition, the communication node may report the channel state information acquisition capability information to the base station before receiving the first signal on the first resource.

Only as an example rather than a limitation, the channel state information acquisition capability information may include at least one of:
a minimum time domain density of the first signal required for acquiring channel state information, such as a real number or greater than 0;
a maximum interval on the time domain of the first signal required for acquiring channel state information, such as L wireless frames, subframes, slots, symbols, or the like, where L is an integer not less than 0;
a time domain range in which channel state information may be acquired, such as the last wireless frame, subframe, slot or symbol where the first resource is located, or T wireless frames, subframes, slots or symbols after the last wireless frame, subframe, slot or symbol where the first resource is located, wherein T is an integer not less than 0;
a minimum frequency domain density of the first signal required for acquiring channel state information, such as a real number or greater than 0;
a maximum interval on the frequency domain of the first signal required for acquiring channel state information, such as K sub-bands, bandwidth parts, physical resource blocks, subcarriers, or the like, wherein K is an integer not less than 0;
a frequency domain range in which channel state information may be acquired, such as the initial sub-band, bandwidth part, physical resource block, subcarrier or the like where the first resource is located, or F sub-bands, bandwidth parts, physical resource blocks, subcarriers, or the like before the initial sub-band, bandwidth part, physical resource block, subcarrier or the like where the first resource is located, wherein F is an integer not less than 0; or
a minimum space domain density of the first signal required for acquiring channel state information, such as a ratio ρₛ of the number of physical antenna units, antenna arrays containing a plurality of physical antenna units, beams, or antenna ports of the first signal needs to be configured, to the number of all the physical antenna units, antenna arrays containing a plurality of physical antenna units, beams, or antenna ports, wherein ρₛ is a real number greater than 0.

Such an embodiment may provide configuration basis or reference of the first signaling to the service cell or base station which the communication node accesses, so that the service cell or base station which the communication node accesses may configure the first resource and/or the second resource reasonably according to the capability of the communication node, and will not cause the communication node cannot acquire the accurate channel state information because of configuring too few first resources and/or the second resources that are offset too much from the first resources, or will not cause the waste of the downlink signal overhead for acquiring the channel state information because of configuring too many first resources.

Only as an example rather than a limitation, the channel state information acquisition capability may be a capability level and/or a capability indication, wherein different capability levels and/or capability indications may correspond to the channel state information acquisition capabilities of different ranges.

For example, the channel state information acquisition capability corresponding to the capability level and/or the capability indication N may be at least one of:

$${ρ}_{T} - {ρ}_{T}^{N} \leq {ρ}_{T} \leq {ρ}_{T} + {ρ}_{T}^{N} , {ρ}_{F} - {ρ}_{F}^{N} \leq {ρ}_{F} \leq {ρ}_{F} + {ρ}_{F}^{N} ,$$

$${ρ}_{S} - {ρ}_{S}^{N} \leq {ρ}_{S} \leq {ρ}_{S} + {ρ}_{S}^{N} , L - {L}^{N} \leq L \leq L + {L}^{N} , K - {K}^{N} \leq K \leq K + {K}^{N} ,$$

$$T - {T}^{N} \leq T \leq T + T , F - {F}^{N} \leq F \leq F + {F}^{N} ,$$

wherein N is an integer not less than 0, ρ^{N}_{T}, ρ^{N}_{F}, ρ^{N}_{S} is a real number greater than 0, and L^{N}, K^{N}, T^{N} and F^{N} are integers not less than 0.

Such an embodiment may reduce the overhead of physical resources used by the communication node for reporting the capability, thereby further improving the utilization efficiency of the physical resources by the wireless communication network.

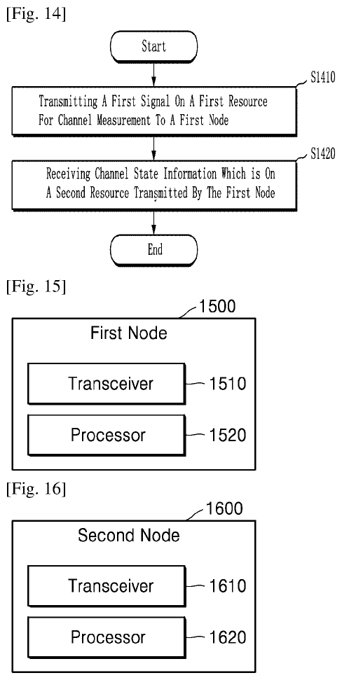

FIG. 14 illustrates a flowchart of a method performed by a second node in a wireless communication system according to an embodiment of the present disclosure.

Here, the second node may be a communication node. The method performed by the second node in the wireless communication system according to the embodiment of the present disclosure may be applied to a signaling design and the interaction procedure of the base station of the previous embodiments.

Referring to FIG. 14, in step S1410, a first signal on a first resource for channel measurement may be transmitted to a first node.

In step S1420, channel state information which is on a second resource transmitted by the first node may be received.

In addition, the method may further include: transmitting first information regarding the second resource to the first node.

Only as an example rather than a limitation, the first information may include at least one of information of a time domain resource, information of a frequency domain resource, information of a space domain resource or information on a position of the second resource relative to the first resource, wherein the information on the position of the second resource relative to the first resource may be at least one of an offset of the time domain resource and an offset of the frequency domain resource.

The information on the position of the second resource relative to the first resource may include at least one of: an offset between an initial time domain physical resource of the second resource and an initial time domain physical resource of the first resource; an offset between the initial time domain physical resource of the second resource and an end time domain physical resource of the first resource; an offset between an end time domain physical resource of the second resource and the initial time domain physical resource of the first resource; an offset between the end time domain physical resource of the second resource and the end time domain physical resource of the first resource; an offset between an initial frequency domain physical resource of the second resource and an initial frequency domain physical resource of the first resource; an offset between the initial frequency domain physical resource of the second resource and an end frequency domain physical resource of the first resource; an offset between an end frequency domain physical resource of the second resource and the initial frequency domain physical resource of the first resource; or an offset between the end frequency domain physical resource of the second resource and the end frequency domain physical resource of the first resource.

In addition, the method may further include: receiving capability information transmitted by the first node, wherein the capability information may include at least one of: information of a minimum time domain density of the first signal required for acquiring channel state information, information of a maximum time domain interval of the first signal required for acquiring channel state information, information of a time domain range in which channel state information is acquired, information of a minimum frequency domain density of the first signal required for acquiring channel state information, information of a maximum frequency domain interval of the first signal required for acquiring channel state information, information of a frequency domain range in which channel state information is acquired, or information of a minimum space domain density of the first signal required for acquiring channel state information.

In addition, the method may further include: transmitting, to the first node, second information for channel state information measurement and/or report, wherein the channel state information measurement and/or report may include at least one of: measuring and/or reporting the channel state information which is on the first resource, or measuring and/or reporting the channel state information which is on the second resource.

In addition, the method may further include: transmitting, to the first node, third information on time when the channel state information is reported, wherein the third information may include at least one of: an offset between a time point at which the first node receives the first signal and a latest time point at which the first node reports the channel state information; or an offset between a latest time point at which the first node reports the channel state information which is on the first resource and a latest time point at which the first node reports the channel state information which is on the second resource.

FIG. 15 illustrates a block diagram of a first node 1500 according to an exemplary embodiment of the present disclosure.

As illustrated by FIG. 15, the first node 1500 according to the embodiment of the present disclosure may include a transceiver 1510, a processor 1520 and a memory 1530. However, all of the illustrated components are not essential. The first node 1500 may be implemented by more or less components than those illustrated in FIG. 15. In addition, a transceiver 1510, a processor 1520 and a memory 1530 may be implemented as a single chip according to another embodiment.

The first node 1500 may correspond to a user equipment (UE) in 3GPP, for example UE 111-116 in FIG. 1. The first node 1500 may be configured to execute the method of FIG. 13. Also, the first node 1500 may be configured to execute the methods described in present disclosure.

The aforementioned components will now be described in detail.

The processor 1520 may include one or more processors or other processing devices that control the proposed function, process, and/or method. Operation of the first node 1500 aforementioned in this disclosure may be implemented by the processor 1520.

The transceiver 1510 may be configured to receive a first signal on a first resource for channel measurement, determine a second resource, and report channel state information which is on the second resource. Other operations executed by the first node 1510 are the same as those of the method of FIG. 13, which will not be repeated here again.

The transceiver 1510 may include a RF transmitter for up-converting and amplifying a transmitted signal, and a RF receiver for down-converting a frequency of a received signal. However, according to another embodiment, the transceiver 1510 may be implemented by more or less components than those illustrated in components.

The transceiver 1510 may be connected to the processor 1520 and transmit and/or receive a signal. The signal may include control information and data. In addition, the transceiver 1510 may receive the signal through a wireless channel and output the signal to the processor 1520. The transceiver 1510 may transmit a signal output from the processor 1520 through the wireless channel.

The memory 1530 may store the control information or the data included in a signal obtained by the first node 1500. The memory 1530 may be connected to the processor 1520 and store at least one instruction or a protocol or a parameter for the proposed function, process, and/or method. The memory 1530 may include read-only memory (ROM) and/or random access memory (RAM) and/or hard disk and/or CD-ROM and/or DVD and/or other storage devices.

FIG. 16 illustrates a block diagram of a second node 1600 according to an embodiment of the present disclosure.

As illustrated by FIG. 16, the second node 1600 according to the exemplary embodiment of the present disclosure may include a transceiver 1610, a processor 1620 and a memory 1630. However, all of the illustrated components are not essential. The second node 1600 may be implemented by more or less components than those illustrated in FIG. 16. In addition, a transceiver 1610, a processor 1620 and a memory 1630 may be implemented as a single chip according to another embodiment.

The second node 1600 may correspond to a base station (BS) in 3GPP, for example gNodeB 101-103 in FIG. 1. The second node 1600 may be configured to execute the method of FIG. 14. Also, the second node 1600 may be configured to execute the methods described in present disclosure.

The aforementioned components will now be described in detail.

The processor 1620 may include one or more processors or other processing devices that control the proposed function, process, and/or method. Operation of the second node 1600 aforementioned in this disclosure may be implemented by the processor 1620.

The transceiver 1610 may be configured to transmit a first signal on a first resource for channel measurement to the first node, and receive channel state information the second resource transmitted by the first node. Other operations executed by the second node 1600 are the same as those of the method of FIG. 14, which will not be repeated here again.

The transceiver 1610 may include a RF transmitter for up-converting and amplifying a transmitted signal, and a RF receiver for down-converting a frequency of a received signal. However, according to another embodiment, the transceiver 1610 may be implemented by more or less components than those illustrated in components.

The transceiver 1610 may be connected to the processor 1620 and transmit and/or receive a signal. The signal may include control information and data. In addition, the transceiver 1610 may receive the signal through a wireless channel and output the signal to the processor 1620. The transceiver 1610 may transmit a signal output from the processor 1620 through the wireless channel.

The memory 1630 may store the control information or the data included in a signal obtained by the second node 1600. The memory 1630 may be connected to the processor 1620 and store at least one instruction or a protocol or a parameter for the proposed function, process, and/or method. The memory 1630 may include read-only memory (ROM) and/or random access memory (RAM) and/or hard disk and/or CD-ROM and/or DVD and/or other storage devices.

According to an embodiment of the present disclosure, there may further be provided an electronic apparatus, including a memory and a processor, the memory storing computer-executable instructions, wherein when the instructions are executed by the processor, the aforementioned method is executed.

According to an embodiment of the present disclosure, there may further be provided a computer readable storage medium storing instructions, wherein the instructions, when executed by at least one processor, cause the at least one processor to execute the aforementioned method.

Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CDRW, CD+RW, DVD-ROM, DVD-R, DVD+R, DVD-RW, DVD+RW, DVD-RAM, BD-ROM, BD-R, BD-R LTH, BD-RE, blu-ray or optical disc storage, Hard Disk Drive (HDD), Solid State Drive (SSD), card storage (such as, multimedia cards, secure digital (SD) cards or extreme speed digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to the processor or computer so that the processor or computer may execute the computer programs. The instructions or computer programs in the above-mentioned computer-readable storage medium my run in an environment deployed in a computer apparatus such as a client, a host, an agent device, a server, or the like.

In addition, in one example, the computer program and any associated data, data files and data structures are distributed on networked computer systems, so that the computer programs and any associated data, data files and data structures are stored, accessed, and executed in a distributed manner through one or more processors or computers.

In addition, computer-readable storage media may be provided in the form of non-transitory storage media. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to the embodiment of the present disclosure, by using the neural network including the plurality of cascaded sub-neural networks, the communication node may be enabled to accurately acquire the channel state information through reference signals with lower density and/or lower number distribution (e.g., sounding reference signals, channel state information reference signals, demodulation reference signals, etc.), thereby reducing a resource overhead of the reference signal, and improving a resource utilization rate and performance of the wireless communication system; According to the physical resource dimensions where the channel state information that needs to be acquired is located, different sub-neural networks are cascaded to obtain the channel state information that needs to be acquired on all the physical resource dimensions, so that the communication node may accurately acquire the channel state information through multiple lightweight sub-neural networks, thereby reducing storage resources required to store neural network parameters and computing resources required to run the neural network. Meanwhile, each of lightweight sub-neural network models may be trained independently, which greatly reduces difficulty in training the neural network model. On another aspect, by using the related information, the neural network may be enabled to acquire priori information implied in the related information, so that output accuracy of the neural network is improved, and the neural network may be enabled to flexibly adjust a range of its output channel state information through the resource position where the unknown channel state information is located.

At least one of the above plurality of modules may be implemented through an AI model. Functions associated with AI may be performed by a non-volatile memory, a volatile memory and a processor.

As an example, the electronic apparatus may be a PC computer, a tablet device, a personal digital assistant, a smart phone, or any other device capable of executing the above indication set. Here, the electronic apparatus does not have to be a single electronic apparatus, and may also be any aggregate of devices or circuits that can execute the above-mentioned indications (or indication sets) individually or jointly. The electronic apparatus may also be a part of an integrated control system or a system manager, or may be a portable electronic device configured to be interconnected with the local or remote (e.g., via wireless transmission) via interfaces. The processor may include one or more processors. At this point, one or more processors may be general-purpose processors, such as central processing units (CPUs), application processors (APs), etc., processors only for graphics (such as graphics processors (GPUs), visual processors (VPUs), and/or AI dedicated processors (such as neural processing units (NPUs)). One or more processors control the processing of input data according to predefined operation rules or AI models stored in non-volatile memory and volatile memory. The predefined operation rules or AI models may be provided through training or learning. Here, providing by learning means applying learning algorithms to multiple learning data to form predefined operation rules or AI models with desired features. The learning may be performed in the device itself that executes AI according to the embodiment, and/or may be implemented by a separate server/device/system.

A learning algorithm is a method that uses multiple learning data to train a predetermined target device (for example, a robot) to make, allow or control the target device to make a determination or prediction. Examples of learning algorithms include but are not limited to supervised learning, unsupervised learning, semi-supervised learning or reinforcement learning.

AI models may be obtained through training. Here, “obtained through training” refers to training a basic AI model with multiple training data through a training algorithm to obtain predefined operation rules or AI models, which are configured to perform the required features (or purposes).

As an example, the AI model may include multiple neural network layers. Each of the multiple neural network layers includes a plurality of weight values, and a neural network calculation is performed by performing calculation between the calculation results of the previous layer and the multiple weight values. Examples of neural networks include, but are not limited to, Convolutional Neural Networks (CNNs), Deep Neural Networks (DNNs), Recursive Neural Networks (RNNs), Restricted Boltzmann Machines (RBMs), Deep Confidence Networks (DBNs), Bidirectional Recursive Deep Neural Networks (BRDNNs), Generative Confrontation Networks (GANs) and deep Q networks.

The processor may run indications or codes stored in the memory, wherein the memory may also store data. Instructions and data may also be transmitted and received over a network via a network interface device, wherein the network interface device may use any known transmission protocol.

The memory may be integrated with the processor, for example, RAM or flash memory is arranged in an integrated circuit microprocessor or the like. In addition, the memory may include a separate device, such as an external disk drive, a storage array, or any other storage device that can be used by a database system. The memory and the processor may be operatively coupled, or may communicate with each other, for example, through an I/O port, a network connection or the like, so that the processor can read files stored in the memory.

In addition, the electronic apparatus may also include a video display (such as a liquid crystal display) and a user interaction interface (such as a keyboard, a mouse, a touch input device, etc.). All components of the electronic apparatus may be connected to each other via a bus and/or a network.

It should be explained that terms “first”, “second”, “third”, “1”, “2” and the like in the description and the claims as well as the drawings of the present application are used to distinguish similar objects, and are not necessary to be used to describe specific order or sequence. It should be understood that the data used in this way may be interchanged under appropriate circumstances so that the embodiments of the present application described herein may be implemented in an order other than those illustrated or described herein.

It should be understood that although various operation steps are indicated by arrows in the flowcharts of the embodiments of the present application, the order in which these steps are implemented is not limited to the order indicated by the arrows. The implementation steps in each of the flowcharts may be carried out in other orders according to the requirements in some application scenarios of the embodiments of the present application, unless specifically stated. In addition, some or all of the steps in each flowchart may include multiple sub-steps or multiple stages based on the actual implementation scenarios. Some or all of these sub-steps or stages may be executed at the same time, and each of these sub-steps or stages may also be executed at different times, respectively. In scenarios with different execution times, an execution order of these sub-steps or stages may be flexibly configured according to needs, and not be limited by the embodiments of the present application.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

Although the present disclosure has been illustrated and described with reference to particular exemplary embodiments thereof, it will be understood by those skilled in the art that various changes in form and details may be made therein without departing from the spirit and scope of the present disclosure as defined by the claims or the equivalents thereof.

1. A method performed by a first node in a wireless communication system, comprising:
receiving a first signal on a first resource for channel measurement;
determining a second resource; and
reporting channel state information on the second resource.

2. The method of claim 1, wherein the determining of the second resource comprises at least one of:
determining the second resource based on first information regarding the second resource received from a second node; or
determining the second resource based on the first resource.

3. The method of claim 2, wherein the determining of the second resource based on the first resource comprises determining the second resource as at least one of:
sub-bands, bandwidth parts (BWPs) or frequency bands where the first resource is located; or
sub-bands, bandwidth parts (BWPs) or frequency bands adjacent to the first resource.

4. The method of claim 2, wherein the first information regarding the second resource comprises at least one of:
information of a time domain resource,
information of a frequency domain resource,
information of a space domain resource, or
information on a position of the second resource relative to the first resource.

5. The method of claim 4, wherein the information on the position of the second resource relative to the first resource comprises at least one of:
an offset between an initial time domain physical resource of the second resource and an initial time domain physical resource of the first resource;
an offset between the initial time domain physical resource of the second resource and an end time domain physical resource of the first resource;
an offset between an end time domain physical resource of the second resource and the initial time domain physical resource of the first resource;
an offset between the end time domain physical resource of the second resource and the end time domain physical resource of the first resource;
an offset between an initial frequency domain physical resource of the second resource and an initial frequency domain physical resource of the first resource;
an offset between the initial frequency domain physical resource of the second resource and an end frequency domain physical resource of the first resource;
an offset between an end frequency domain physical resource of the second resource and the initial frequency domain physical resource of the first resource; or
an offset between the end frequency domain physical resource of the second resource and the end frequency domain physical resource of the first resource.

6. The method of claim 1, further comprising:
reporting capability information, wherein the capability information comprises at least one of:
information of a minimum time domain density of the first signal required for acquiring channel state information,
information of a maximum time domain interval of the first signal required for acquiring channel state information,
information of a time domain range in which channel state information is acquired,
information of a minimum frequency domain density of the first signal required for acquiring channel state information,
information of a maximum frequency domain interval of the first signal required for acquiring channel state information,
information of a frequency domain range in which channel state information is acquired, or
information of a minimum space domain density of the first signal required for acquiring channel state information.

7. The method of claim 1, further comprising:
receiving, from the second node, second information including indication information of on which resource measuring and/or reporting channel state information,
wherein the channel state information measurement and/or report comprises at least one of:
measuring and/or reporting the channel state information which is on the first resource, or
measuring and/or reporting the channel state information which is on the second resource.

8. The method of claim 1, further comprising:
determining the channel state information measurement and/or report according to whether the first information is received,
wherein, measuring and/or reporting the channel state information which is on the second resource when the first information is received; and
wherein, measuring and/or reporting the channel state information which is on the first resource when the first information is not received.

9. The method of claim 1, further comprising:
receiving third information on time when the channel state information is reported,
wherein the third information comprises at least one of:
an offset between a time point at which the first node receives the first signal and a latest time point at which the first node reports the channel state information; or
an offset between a latest time point at which the first node reports the channel state information which is on the first resource and a latest time point at which the first node reports the channel state information which is on the second resource.

10. The method of claim 1, further comprising: determining the time when the channel state information is reported on the second resource according to at least one of:
an interval between subcarriers;
a capability reported by the first node; or
channel state information that needs to be reported configured by the second node.

11. The method of claim 1, wherein:
the channel state information which is on the second resource is acquired through a neural network,
wherein the neural network comprises a plurality of cascaded sub-neural networks, wherein at least one of the plurality of sub-neural networks is used for acquiring channel state information which is on partial resource of the second resource.

12. A method performed by a second node in a wireless communication system, comprising:
transmitting a first signal on a first resource for channel measurement to a first node; and
receiving channel state information on a second resource from the first node.

13. The method of claim 12, further comprising:
transmitting first information regarding the second resource to the first node,
wherein the first information comprises at least one of:
information of a time domain resource,
information of a frequency domain resource,
information of a space domain resource, or
information on a position of the second resource relative to the first resource.

14. A first node in a wireless communication system, comprising:
a transceiver; and
a controller coupled to the transceiver and configured to:
receive a first signal on a first resource for channel measurement;
determine a second resource; and
report channel state information on the second resource.

15. A second node in a wireless communication system, comprising:
a transceiver; and
a controller coupled to the transceiver and configured to:
transmit a first signal on a first resource for channel measurement to a first node; and
receive channel state information on a second resource from the first node.
